(19) United States
(12) Patent Application Publication
(10) Pub. No.: US 2024/0340665 A1
(43) Pub. Date: Oct. 10, 2024

(54) ENHANCEMENTS TO V2X MESSAGING TO IMPROVE MISBEHAVIOR DETECTION PERFORMANCE

(71) Applicant: QUALCOMM Incorporated, San Diego, CA (US)

(72) Inventors: Mohit NARULA, San Diego, CA (US); Mohammad Raashid ANSARI, Lowell, MA (US); Jean-Philippe MONTEUUIS, Northborough, MA (US); Jonathan PETIT, Wenham, MA (US); Cong CHEN, San Diego, CA (US)

(21) Appl. No.: 18/297,566

(22) Filed: Apr. 7, 2023

(51) Int. Cl. H04W 24/08

(52) U.S. Cl. CPC H04W 24/08; H04W 84/18

(57) ABSTRACT

A method of wireless communication at a V2X device is disclosed herein. The method includes detecting that at least one sensor of the V2X device has become non-operational or unreliable. The method includes transmitting, for at least one network node based on the detection, at least one message that includes information regarding the at least one sensor becoming non-operational or unreliable, where the at least one message includes at least one field for the information.

### TECHNICAL FIELD

The present disclosure relates generally to communication systems, and more particularly, to vehicle-to-everything (V2X) communications.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a vehicle-to-everything (V2X) device are provided. The apparatus includes a memory; and at least one processor coupled to the memory and, based at least in part on information stored in the memory, the at least one processor is configured to detect that at least one sensor of the V2X device has become non-operational or unreliable; and transmit, for at least one network node based on the detection, at least one message that includes information regarding the at least one sensor becoming non-operational or unreliable, where the at least one message includes at least one field for the information.

In an aspect of the disclosure, a method, a computer-readable medium, and an apparatus for wireless communication at a network node device are provided. The apparatus includes a memory; and at least one processor coupled to the memory and, based at least in part on information stored in the memory, the at least one processor is configured to receive, from a vehicle-to-everything (V2X) device, at least one message that includes information about at least one sensor of the V2X device becoming non-operational or unreliable, where the at least one message includes at least one field for the information; and perform, based on the at least one message, at least one action pertaining to the at least one sensor of the V2X device becoming non-operational or unreliable.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network in accordance with various aspects of the present disclosure.

FIG. 4 is a diagram illustrating an example of wireless communication between wireless devices based on sidelink (SL) communication in accordance with various aspects of the present disclosure.

FIG. 5A is a diagram illustrating an example of a first resource allocation mode for SL communication in accordance with various aspects of the present disclosure.

FIG. 5B is a diagram illustrating an example of a second resource allocation mode for SL communication in accordance with various aspects of the present disclosure.

FIG. 6 is a diagram illustrating an example structure of a sidelink resource pool in accordance with various aspects of the present disclosure.

FIG. 7 is a diagram illustrating an example of a collective perception message (CPM) in accordance with various aspects of the present disclosure.

FIG. 8 is a diagram illustrating an example of a CPM in accordance with various aspects of the present disclosure.

FIG. 9 is a diagram illustrating an example of a CPM in accordance with various aspects of the present disclosure.

FIG. 10 is a diagram illustrating an example of a CPM in accordance with various aspects of the present disclosure.

FIG. 11 is a diagram illustrating an example of a CPM in accordance with various aspects of the present disclosure.

FIG. 12 is a diagram illustrating an example of a CPM including information pertaining to sensor status in accordance with various aspects of the present disclosure.

FIG. 13 is a diagram illustrating an example of an equipment malfunction message in accordance with various aspects of the present disclosure.

FIG. 14 is a diagram illustrating example aspects of misbehavior detection in vehicle-to-everything (V2X) communication in accordance with various aspects of the present disclosure.

FIG. 15 is a diagram illustrating an example process for transmitting an equipment malfunction message in accordance with various aspects of the present disclosure.

FIG. 16 is a diagram illustrating example communications exchanged between a V2X enabled vehicular platoon in accordance with various aspects of the present disclosure.

FIG. 17 is a diagram illustrating example communications exchanged between V2X devices in accordance with various aspects of the present disclosure.

FIG. 18 is a diagram illustrating example communications exchanged between a V2X device and a network node in accordance with various aspects of the present disclosure.

FIG. 19 is a flowchart of a method of wireless communication in accordance with various aspects of the present disclosure.

FIG. 20 is a flowchart of a method of wireless communication in accordance with various aspects of the present disclosure.

FIG. 21 is a flowchart of a method of wireless communication in accordance with various aspects of the present disclosure.

FIG. 22 is a flowchart of a method of wireless communication in accordance with various aspects of the present disclosure.

FIG. 23 is a diagram illustrating an example of a hardware implementation for an example apparatus in accordance with various aspects of the present disclosure.

FIG. 24 is a diagram illustrating an example of a hardware implementation for an example network entity in accordance with various aspects of the present disclosure.

### DETAILED DESCRIPTION

Vehicle-to-everything (V2X) communications allow vehicles and other devices to communicate wirelessly with one another, and as such may facilitate or enable features such as cooperative navigation (i.e., vehicular platooning) and safety features. For instance, a V2X-equipped vehicle may broadcast a message (e.g., a collective perception message (CPM)) that includes information about objects (e.g., other vehicles, pedestrians, debris, etc.) perceived by the V2X-equipped vehicle and/or a kinematic state of the V2X-equipped vehicle, and other V2X devices may take actions (e.g., actions that facilitate cooperative navigation, safety-related actions, etc.) based on receiving the message. V2X communications may be dependent on trustworthiness of data included in messages. For instance, if a sensor of the V2X-equipped vehicle is non-operational or unreliable (e.g., due to damage to the sensor, a software malfunction, etc.), a message transmitted by the V2X-equipped vehicle may be incorrect, and taking actions based on the message may also be incorrect. For instance, a V2X device may transmit incorrect data or fail to transmit correct data due to a hardware malfunction (e.g., a faulty sensor) or due to a malicious attack by an attacker. Misbehavior detection may refer to detecting that a V2X device (e.g., a V2X equipped vehicle, a road side unit (RSU), etc.) is transmitting incorrect data or that the V2X-device is failing to transmit correct data due to a malicious attack. A RSU may refer to a fixed infrastructure component capable of wireless communication and that has a connection to a network/the cloud. A RSU may have improved sensor processing capability compared to an on-board unit (OBU). An OBU may refer to a device installed in a vehicle that records traffic and driving data and that can connect to RSUs and satellite navigation systems. If a V2X device is detected as misbehaving, the V2X device may be removed from a network and/or messages transmitted by the V2X device may be ignored by other vehicles for safety purposes. Some techniques for misbehavior detection may not inform V2X devices about details of a sensor of a V2X device that has become non-operational or unreliable, and as such, differentiating between misbehavior and a malfunction may be difficult. Furthermore, other techniques for misbehavior detection may rely upon receiver-side detection which may not be suitable in some scenarios.

Various aspects described herein relate generally to V2X communications. Some aspects more specifically relate to improving misbehavior detection for V2X devices. In some examples, a V2X device detects that at least one sensor of the V2X device has become non-operational or unreliable. The V2X transmits for at least one network node based on the detection, at least one message that includes information regarding the at least one sensor becoming non-operational or unreliable, where the at least one message includes at least one field for the information.

Particular aspects of the subject matter described in this disclosure can be implemented to realize one or more of the following potential advantages. In some examples, by detecting that the sensor of the V2X device has become non-operational or unreliable and transmitting the at least one message that includes information regarding the at least one sensor becoming non-operational or unreliable, the above-described technologies may result in more accurately distinguishing between misbehavior and malfunctions. Furthermore, the above-described technologies may improve misbehavior detection techniques by not utilizing known faulty inputs. Additionally, unlike some techniques for misbehavior technologies, the above-described technologies may utilize transmitter-side detection.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure.

One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

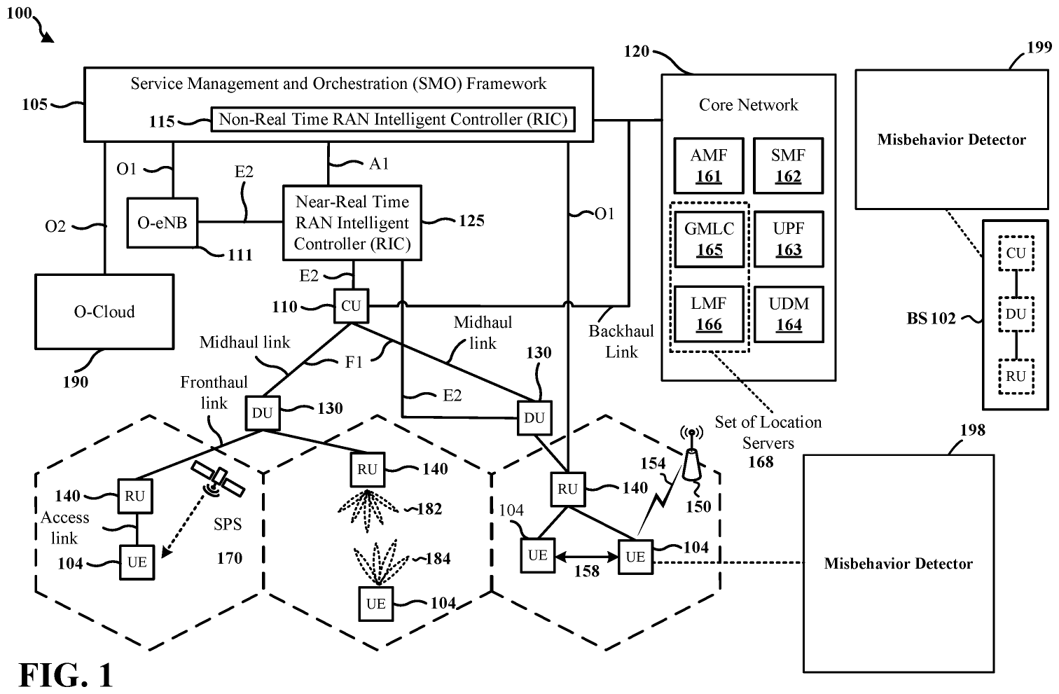

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 702.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHz), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a misbehavior detector 198 that may be configured to detect that at least one sensor of the V2X device has become non-operational or unreliable; and transmit, for at least one network node based on the detection, at least one message that includes information regarding the at least one sensor becoming non-operational or unreliable, where the at least one message includes at least one field for the information. In certain aspects, the base station 102 may have a misbehavior detector 199 that may be configured to receive, from a V2X device, at least one message that includes information about at least one sensor of the V2X device becoming non-operational or unreliable, where the at least one message includes at least one field for the information; and perform, based on the at least one message, at least one action pertaining to the at least one sensor of the V2X device becoming non-operational or unreliable.

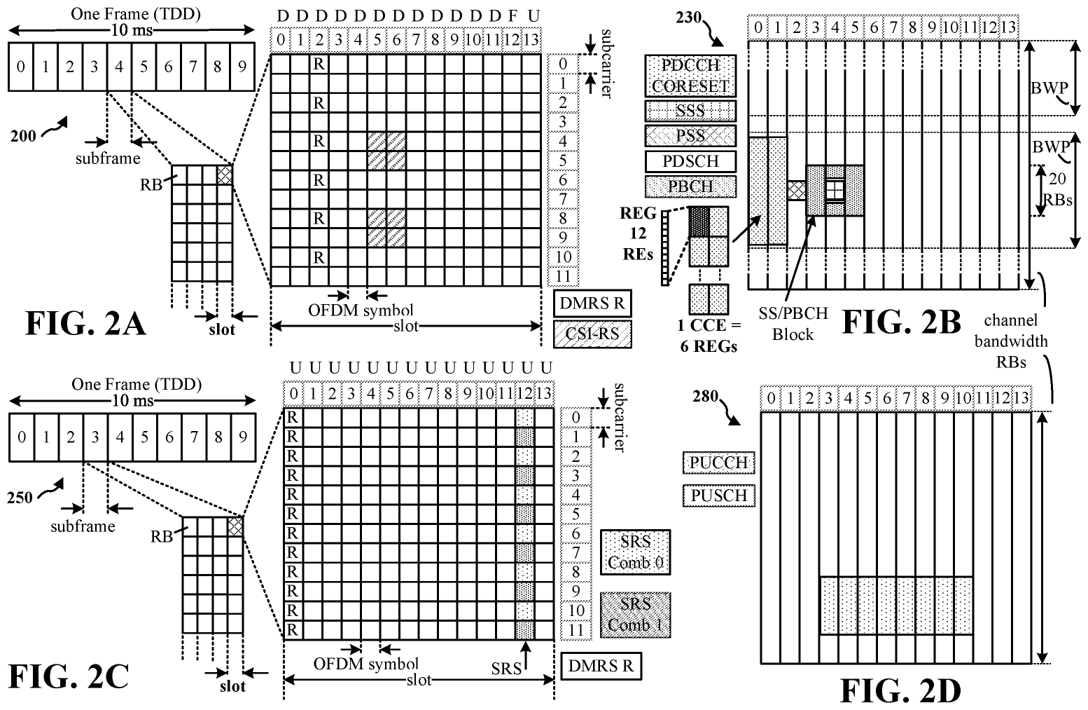

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies u 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

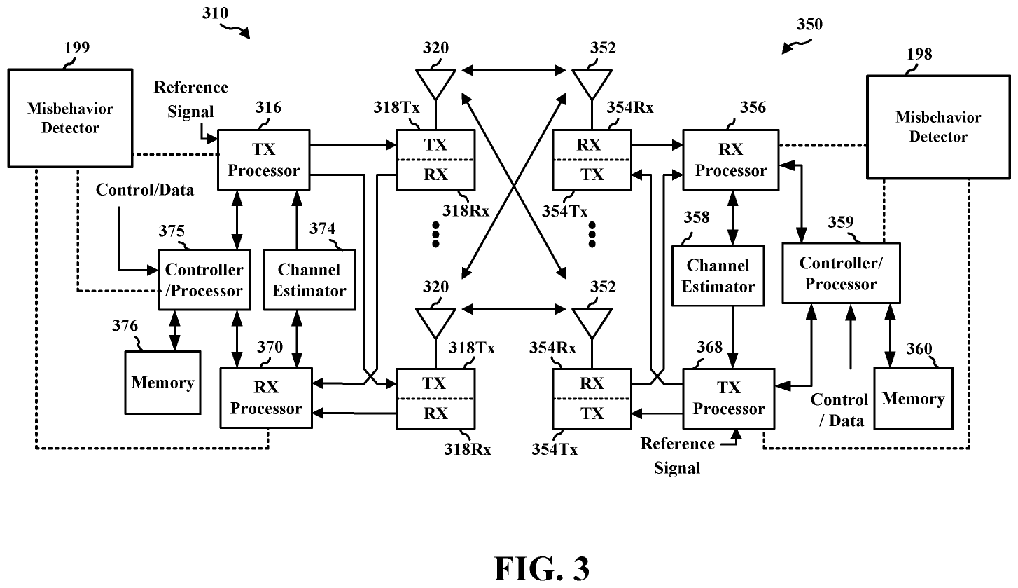

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions, Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the misbehavior detector 198 of FIG. 1.

At least one of the TX processor 316, the RX processor 370, and the controller/processor 375 may be configured to perform aspects in connection with the misbehavior detector 199 of FIG. 1.

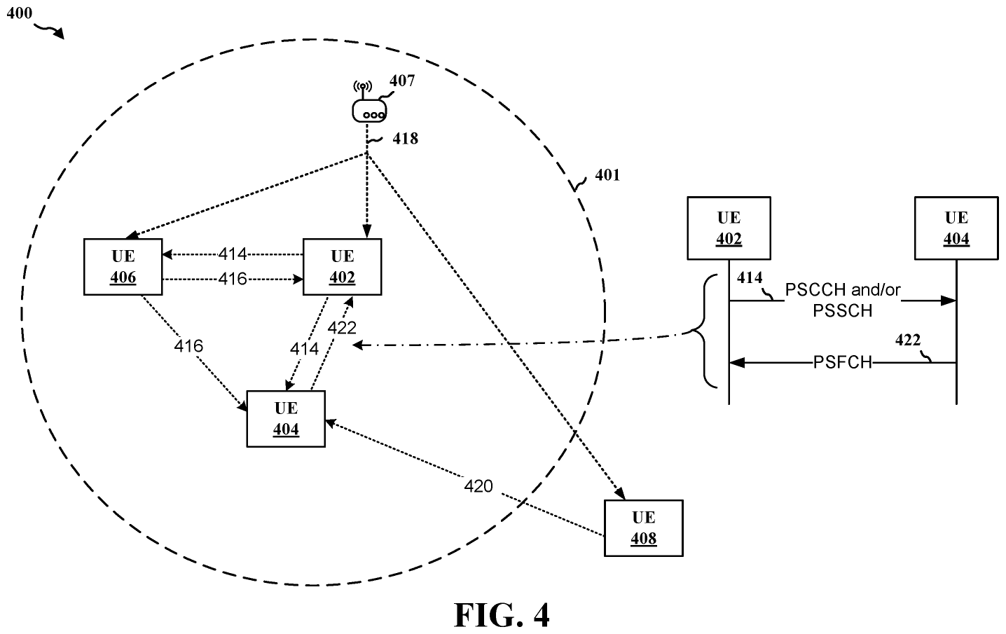

FIG. 4 is a diagram 400 illustrating an example of wireless communication between wireless devices based on sidelink (SL) communication in accordance with various aspects of the present disclosure. In one example, a UE 402 may transmit a transmission 414, e.g., including a control channel (e.g., a physical sidelink control channel (PSCCH)) and a corresponding data channel (e.g., a physical sidelink shared channel (PSSCH)), that may be received by one or more UEs (e.g., UEs 404 and 406). A control channel may include information for decoding the corresponding data channel, and it may also be used by a receiving UE for avoiding interference (e.g., UEs 404 and 406 may be refrained from transmitting data on resources occupied/reserved by the UE 402). For example, the UE 402 may indicate the number of transmission time intervals (TTIs) and the resource blocks (RBs) that are to be occupied by a transmission from the UE 402 in a control message (e.g., a sidelink control information (SCI) message). The UEs 402, 404, 406, and 408 may each have the capability to operate as a transmitting UE in addition to operating as a receiving UE. For example, UEs 404, 406, and 408 may also transmit transmissions 422, 416, and 420, respectively, to other UEs, such as the UEs 402 and 404. The transmissions 414, 416, 420 may be broadcast or multicast to nearby wireless devices or UEs. For example, the UE 402 may transmit communication (e.g., data) for receipt by other UEs within a range 401 of the UE 402. Additionally, or alternatively, a road side unit (RSU) 407 may be used to provide connectivity and information to sidelink devices, such as by receiving communication from and/or transmitting communication (e.g., communication 418) to UEs 402, 406, and 408.

Sidelink communication that is exchanged directly between UEs (which may be referred to as “sidelink UEs” hereafter) may include discovery messages for a UE to find other nearby UEs. In some examples, the sidelink communication may also include resource reservation information associated with other sidelink UEs, which may be used by a UE for determining/selecting the resources for transmission.

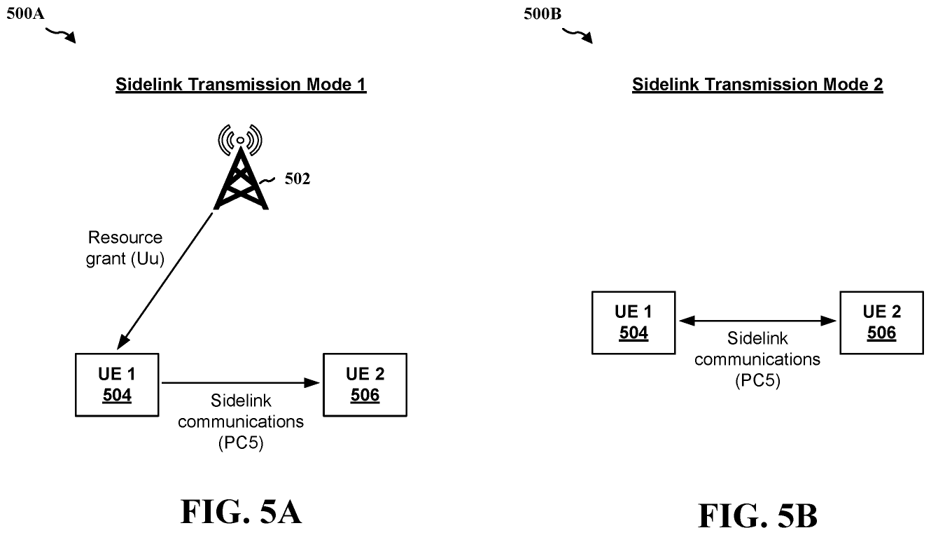

In one example, a sidelink communication may be based on different types or modes of resource allocation mechanisms. As shown by a diagram 500A of FIG. 5A, in a first resource allocation mode (which may be referred to as “Mode 1,” “sidelink transmission Mode 1,” and/or “V2X Mode 1,” etc.), a centralized resource allocation may be provided. For example, under the first resource allocation mode, a base station 502 may determine and allocate sidelink resources for communications between a first UE 504 and a second UE 506. The first UE 504 may receive an indication of the allocated sidelink resources (e.g., a resource grant) from the base station 502 via a UE-to-universal mobile telecommunications system (UMTS) terrestrial radio access network (UE-to-UTRAN) (Uu) link (e.g., via a resource radio control (RRC) message or downlink control information (DCI) (e.g., DCI format 3_0)), and then the first UE 504 may use the allocated sidelink resources for communicating with the second UE 506 over the sidelink (which may also be referred to as a PC5 link).

As shown by a diagram 500B of FIG. 5B, in a second resource allocation mode (which may be referred to as “Mode 2,” “sidelink transmission Mode 2,” and/or “V2X Mode 2,” etc.), a distributed resource allocation may be provided between UEs. For example, under the second resource allocation mode, each UE may autonomously determine sidelink resources for its sidelink transmission. In order to coordinate the selection of sidelink resources by individual UEs, each UE may use a sensing technique to monitor/detect sidelink resources reserved/used by other UEs, and then each UE may select sidelink resources for its sidelink transmissions from unreserved/used sidelink resources. For example, a first UE 504 may sense and select unreserved/unused sidelink resources in a sidelink resource pool based on decoding SCI messages received (e.g., transmitted from a second UE 506 or another UE), and the first UE 504 may use the selected side resources for communicating with the second UE 506. After the first UE 504 selects the sidelink resources for its transmission, the first UE 504 may also transmit/broadcast (e.g., via groupcast or broadcast) to other UEs the sidelink resources used/reserved by the first UE 504 via SCI, such that other UEs may refrain using these sidelink resources to avoid resource collision (e.g., two UEs transmitting simultaneously using same time and frequency resources). Signaling on sidelink may be the same between the two resource allocation modes (e.g., Mode 1 and Mode 2). For example, from a receiving UE's point of view (e.g., the second UE 506), there may be no difference between the two resource allocation modes.

In some examples, a UE receiving a sidelink transmission (which may be referred to as a receiving UE) may be configured to provide feedback (e.g., an acknowledgement (ACK) or a negative acknowledgement (NACK)) to a UE transmitting the sidelink transmission (which may be referred to as a transmitting UE). For example, after the second UE 506 receives a transmission from the first UE 504, the second UE 506 may send an ACK to the first UE 504 via a physical sidelink feedback channel (PSFCH) if the second UE 506 is able to receive and decode the transmission. On the other hand, if the second UE 506 is unable to decode or receive the transmission, the second UE 506 may send a NACK to the first UE 504. In one example, if the transmission from the first UE 504 is a unicast or a groupcast message, the second UE 506 may be configured to transmit an explicit ACK/NACK to the first UE 504 indicating whether the transmission is successfully decoded, e.g., the second UE 506 transmits an ACK if the transmission is successfully decoded and transmits a NACK if the transmission is not successfully decoded. In another example, if the transmission from the first UE 504 is a groupcast message, the second UE 506 may be configured to transmit an implicit NACK, where the second UE 506 may transmit a NACK to the first UE 504 if the second UE 506 is unable to decode or does not receive the transmission. However, the second UE 506 may skip transmitting an ACK if the second UE 506 successfully decodes the transmission.

Sidelink communications may take place in transmission or reception sidelink resource pools. The minimum resource allocation unit in a sidelink resource pool may be a sub-channel in frequency, and the resource allocation in time may be one slot. Some slots in a sidelink resource pool may are not be available for sidelink communications (e.g., may be reserved/configured for other purposes or other types of communications). For example, some slots may contain feedback resources (e.g., a PSFCH). A base station may configure a sidelink resource pool to a set of UEs, such as via an RRC configuration, or the sidelink resource pool may be preloaded on the set of UEs (e.g., via a pre-configuration).

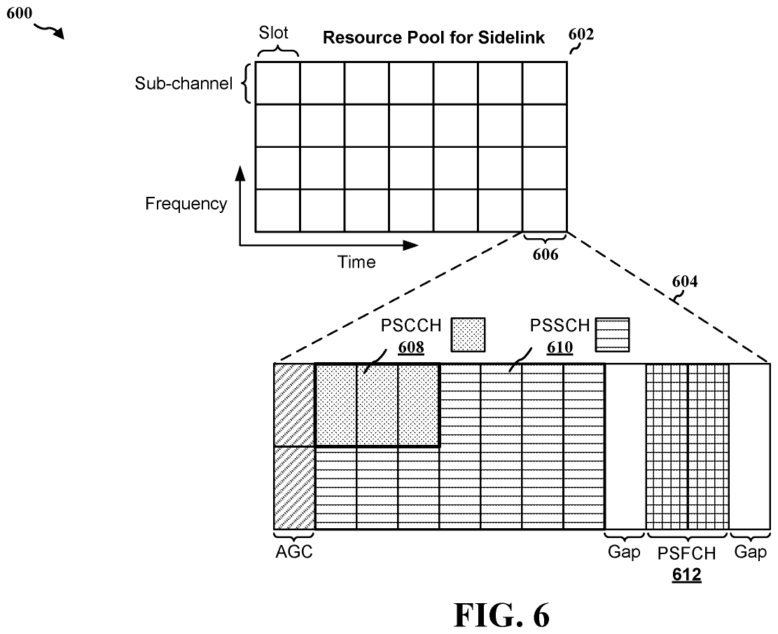

FIG. 6 is a diagram 600 illustrating an example structure of a sidelink resource pool in accordance with various aspects of the present disclosure. A sidelink resource pool 602 may include a set of time and frequency resources (e.g., each slot and sub-channel may indicate a time and frequency resource), and each time and frequency resource may be used by a transmitting UE for transmitting a PSCCH and/or a PSSCH, or used by a receiving UE for transmitting a PSFCH. For example, as shown at 604, a sidelink slot 606 may include resources for a PSCCH 608, a PSSCH 610, and a PSFCH 612. After a receiving UE receives the sidelink slot 606 (e.g., the second UE 506), the receiving UE may first decode the SCI in the PSCCH 608 and/or the PSSCH 610 (e.g., for a two-stage SCI), then decode data in the PSSCH 610. The receiving UE may also receive a feedback via the PSFCH 612 (e.g., for a previous transmission to the transmitting UE), or the receiving UE may also transmit a feedback for the PSSCH 610 via the PSFCH 612.

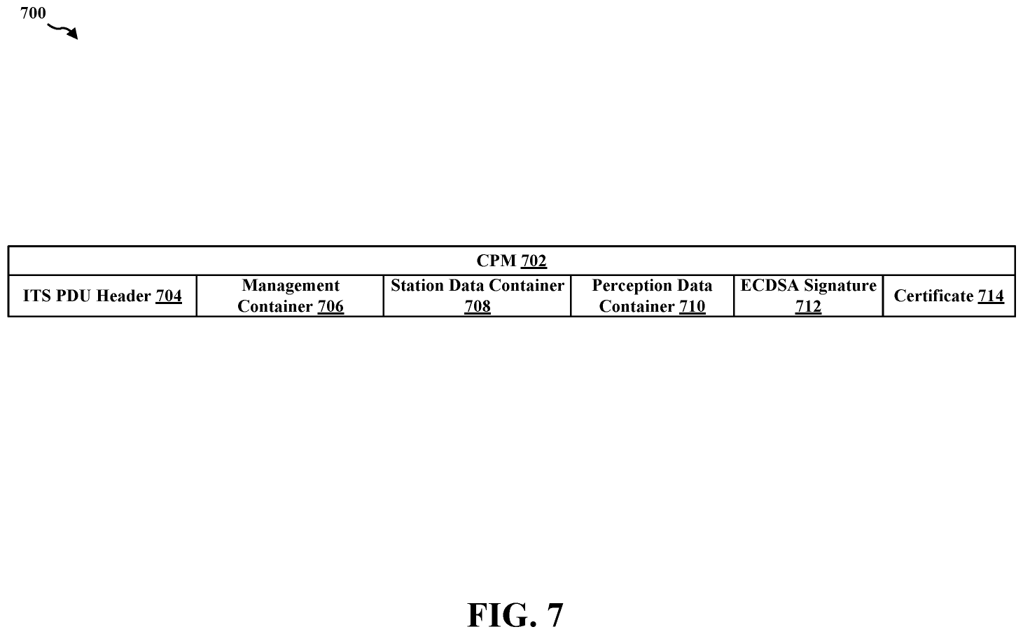

FIG. 7 is a diagram 700 illustrating an example of a CPM 702 in accordance with various aspects of the present disclosure. In general, the CPM 702 may enable a V2X-enabled device (e.g., a V2X-enabled vehicle, a road side unit (RSU), etc.) to share observations with other V2X-enabled devices about object(s) on or near a road that do not include V2X capabilities (e.g., non-V2X vehicles, pedestrians, obstacles, animals, etc.). Collective perception may be defined as the sharing of a perceived environment of a station (e.g., a UE) based on perception sensors. The CPM 702 may be defined as a collective perception basic service PDU. The CPM 702 may enable a collective perception service (CPS). The CPM 702 may complement a basic safety message (BSM) and/or a cooperative awareness message (CAM). BSM may refer to a message standard defined by the Society of Automotive Engineers (SAE). CAM may refer to a message standard defined by the European Telecommunications Standards Institute (ETSI). A BSM and/or a CAM may include information (e.g., a location and/or a kinematic state) about a V2X device. In an example, the CPM 702 may be in a format promulgated by ETSI.

The CPM 702 may include an intelligent transport systems (ITS) protocol data unit (PDU) header (ITS PDU header 704). The ITS PDU header 704 will be discussed in greater detail below.

The CPM 702 may include a management container 706. The management container 706 will be discussed in greater detail below.

The CPM 702 may include a station data container 708. The station data container 708 may include dynamic information of an originating ITS-S.

The CPM 702 may include a perception data container 710. The perception data container 710 may include information about objects perceived by a V2X device.

The CPM 702 may include an elliptical curve digital signature algorithm (ECDSA) signature 712. A V2X device may sign the CPM 702 with the ECDSA signature 712. The CPM 702 may include a certificate 714. The certificate 714 may include a public key of the V2X device. A receiving V2X device may utilize the certificate 714 to verify the ECDSA signature 712.

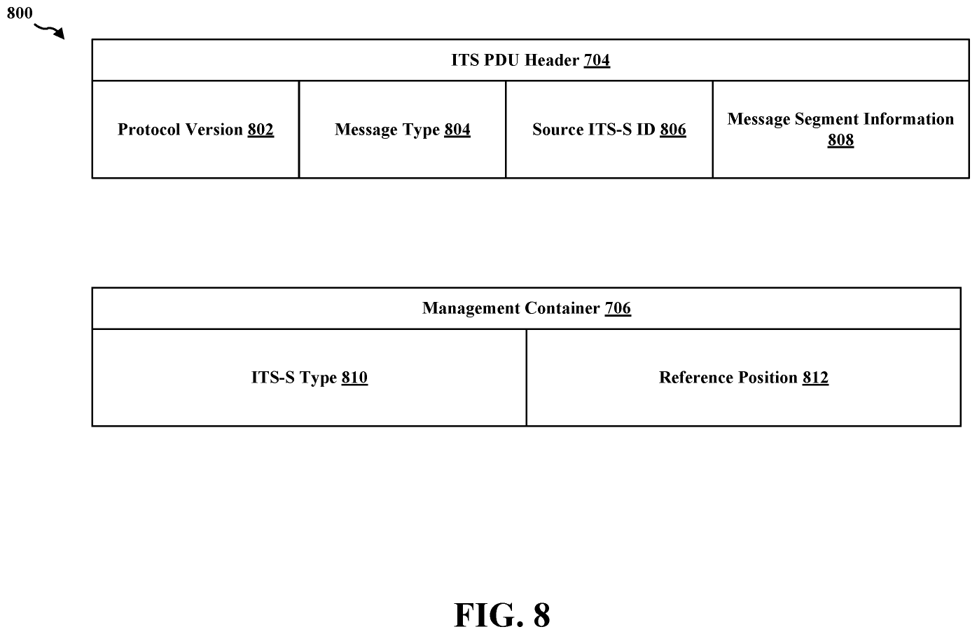

FIG. 8 is a diagram 800 illustrating an example of a CPM in accordance with various aspects of the present disclosure. As discussed above, the CPM 702 may include the ITS PDU header 704. The ITS PDU header 704 may include a protocol version 802 of the CPM 702, a message type 804 of the CPM 702, a source intelligence transport systems sender identifier (source ITS-S ID 806), and message segment information 808. The source ITS-S ID 806 may be an identifier for a V2X device that sends the CPM 702.

As discussed above, the CPM 702 may include the management container 706. The management container 706 may include a ITS-S type 810 (e.g., vehicle, RSU, etc.). The management container 706 may also include a reference position 812 of the V2X device.

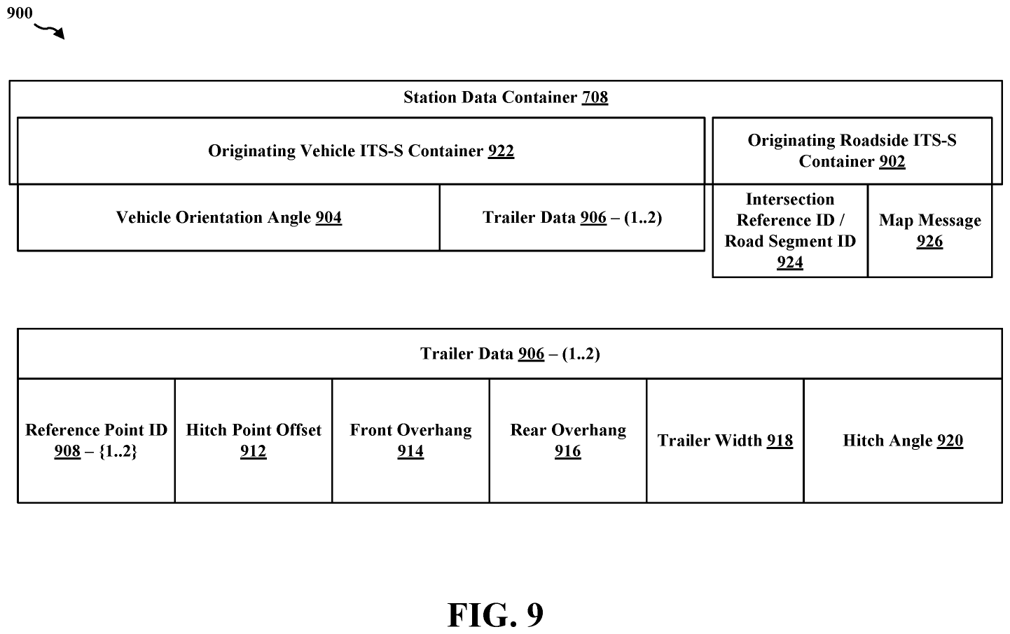

FIG. 9 is a diagram 900 illustrating an example of a CPM in accordance with various aspects of the present disclosure. As discussed above, the CPM 702 may include the station data container 708. The station data container 708 may include an originating vehicle ITS-S container 922. The originating vehicle ITS-S container 922 may include a vehicle orientation angle 904 and trailer data 906. The vehicle orientation angle 904 may be an angle of a vehicle that includes a V2X device. The trailer data 906 may include data about a trailer attached to a vehicle. The trailer data 906 may include a reference point ID 908, a hitch point offset 912, a front overhang 914 of the trailer, a rear overhang 916 of the trailer, a trailer width 918 of the trailer, and a hitch angle 920 of the trailer.

The station data container 708 may include an originating vehicle ITS-S container 902. The originating vehicle ITS-S container 902 may include an intersection reference ID/road segment ID 924. The intersection reference ID/road segment ID 924 may refer to a road infrastructure provided by a road lane topology service. The originating vehicle ITS-S container 902 may include a map message 926. The map message 926 may be transmitted by a RSU and may include data about a geometry of an intersection or a road segment.

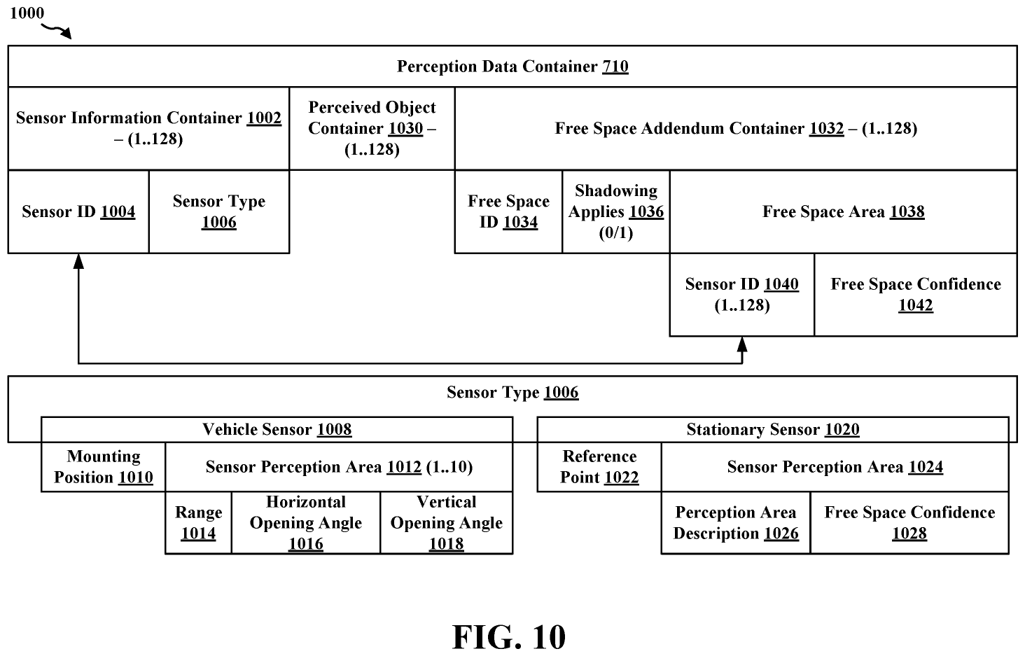

FIG. 10 is a diagram 1000 illustrating an example of a CPM in accordance with various aspects of the present disclosure. As discussed above, the CPM 702 may include the perception data container 710. The perception data container 710 may include a sensor information container 1002. The sensor information container 1002 may include a sensor ID 1004 for a sensor of a V2X device. The sensor information container 1002 may also include a sensor type 1006 for the sensor. The sensor ID 1004 and the sensor type 1006 may be repeated for each sensor of the V2X device.

The sensor type 1006 may include an indication that a sensor is a vehicle sensor 1008. The vehicle sensor 1008 may include an indication of a mounting position 1010 of the sensor. The sensor type 1006 may also include an indication of a sensor perception area 1012. The indication of the sensor perception area 1012 may include a range 1014 of the sensor, a horizontal opening angle 1016 of the sensor, and a vertical opening angle 1018 of the sensor.

The sensor type 1006 may include an indication that the sensor is a stationary sensor 1020 (e.g., the sensor is part of a RSU). The indication of the stationary sensor 1020 may include a reference point 1022 of the sensor and an indication of a sensor perception area 1024. The indication of the sensor perception area 1024 may include a perception area description 1026 and a free space confidence 1028.

The perception data container 710 may include a perceived object container 1030. The perceived object container 1030 may include information about object(s) perceived by the V2X device.

The perception data container 710 may include a free space addendum container 1032. The free space addendum container 1032 may include information about confidence levels for certain areas within a detection area of a particular sensor. The free space addendum container 1032 may include a free space ID 1034, an indication of whether shadowing applies 1036, and an indication of a free space area 1038. The indication of the free space area 1038 may include a sensor ID 1040 and a free space confidence 1042. The sensor ID 1040 may correspond to the sensor ID 1004.

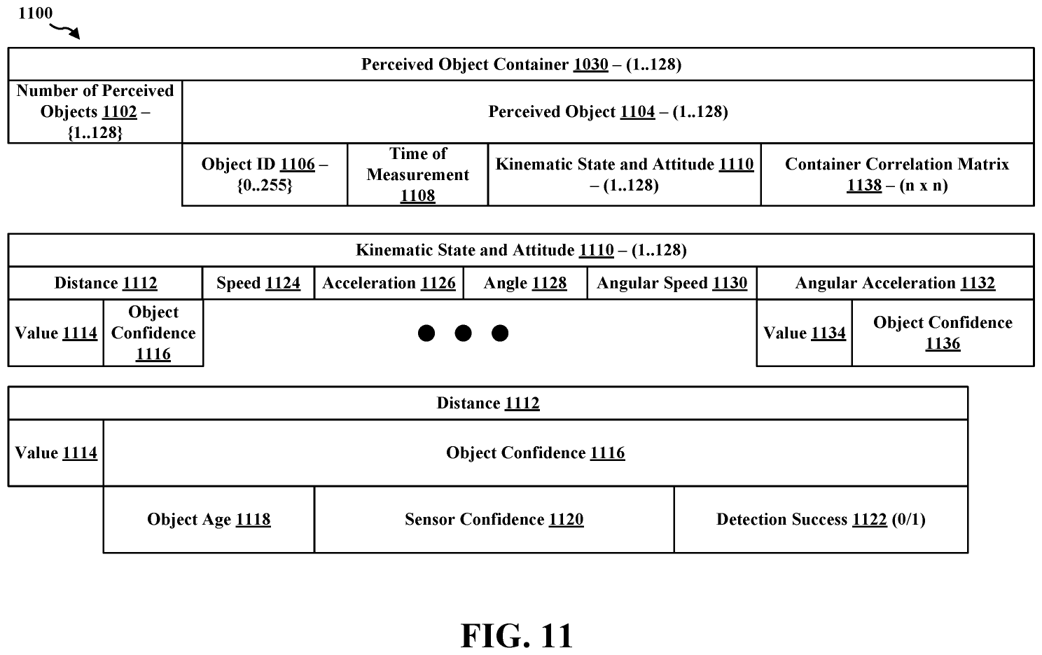

FIG. 11 is a diagram 1100 illustrating an example of a CPM in accordance with various aspects of the present disclosure. As noted above, the perception data container 710 may include a perceived object container 1030. The perceived object container 1030 may include an indication of a number of perceived objects 1102. The perceived object container 1030 may include an indication of a perceived object 1104. The indication of the perceived object 1104 may include an object ID 1106 of an object, a time of measurement 1108 for a measurement performed to perceive the object, a kinematic state and attitude 1110 for the object, and a container correlation matrix 1138. The indication of the perceived object 1104 may include information for each object perceived by the V2X device.

The kinematic state and attitude 1110 for the object may include an indication of a distance 1112 of the object from the V2X device. The indication of the distance 1112 may include a value 1114 and an object confidence 1116 that indicates a confidence in the existence of the object and characteristics of the object.

The object confidence 1116 may include an object age 1118 that indicates an amount of time that the object has been observed by the V2X device. The object confidence 1116 may include a sensor confidence 1120 and an indication as to whether or not detection success 1122 has occurred.

The kinematic state and attitude 1110 may include an indication of speed 1124 of the object, an acceleration of the object 1126, an angle 1128 of the object with respect to the V2X device, an angular speed 1130 of the object, and an angular acceleration 1132 of the object. The angular acceleration 1132 of the object may include a value 1134 for the angular acceleration and an object confidence 1136.

Vehicle-to-everything (V2X) communications allow vehicles and other devices to communicate wirelessly with one another, and as such may facilitate or enable features such as cooperative navigation (i.e., vehicular platooning) and safety features. For instance, a V2X-equipped vehicle may broadcast a message (e.g., a collective perception message (CPM)) that includes information about objects (e.g., other vehicles, pedestrians, debris, etc.) perceived by the V2X-equipped vehicle and/or a kinematic state of the V2X-equipped vehicle, and other V2X devices may take actions (e.g., actions that facilitate cooperative navigation, safety-related actions, etc.) based on receiving the message. V2X communications may be dependent on trustworthiness of data included in the messages. For instance, if a sensor of the V2X-equipped vehicle is non-operational or unreliable (e.g., due to damage to the sensor, a software malfunction, etc.), a message transmitted by the V2X-equipped vehicle may be incorrect, and taking actions based on the message may also be incorrect. For instance, a V2X device may transmit incorrect data or fail to transmit correct data due to a hardware malfunction (e.g., a faulty sensor) or due to a malicious attack by an attacker. Misbehavior detection may refer to detecting that a V2X device (e.g., a V2X equipped vehicle, a road side unit (RSU), etc.) is transmitting incorrect data or that the V2X-device is failing to transmit correct data due to a malicious attack. If a V2X device is detected as misbehaving, the V2X device may be removed from a network and/or messages transmitted by the V2X device may be ignored by other vehicles for safety purposes. Some techniques for misbehavior detection may not inform V2X devices about details of a sensor of a V2X device that has become non-operational or unreliable, and as such, differentiating between misbehavior and a malfunction may be difficult. Furthermore, other techniques for misbehavior detection may rely upon receiver-side detection which may not be suitable in some scenarios.

Various technologies pertaining to improving misbehavior detection for V2X devices are described herein. In an example, a V2X device detects that at least one sensor of the V2X device has become non-operational or unreliable. The V2X transmits for at least one network node based on the detection, at least one message that includes information regarding the at least one sensor becoming non-operational or unreliable, where the at least one message includes at least one field for the information. Vis-à-vis detecting that the sensor of the V2X device has become non-operational or unreliable and transmitting the at least one message that includes information regarding the at least one sensor becoming non-operational or unreliable, the above-described technologies may result in more accurately distinguishing between misbehavior and malfunctions. Furthermore, the above-described technologies may improve misbehavior detection techniques by not utilizing known faulty inputs.

A Collective Perception Message (CPM) structure in V2X communications may not account for sensors being unreliable or inaccurate. This may cause, for example, a receiver to determine that a vehicle is misbehaving, when actually a sensor is malfunctioning on the vehicle. In one aspect, information about sensors (e.g., malfunctioning sensors) may be provided to limit incorrectly identified misbehaviors and associated reporting. The information may include the status of one or more sensors (working/not working), a timestamp of when a sensor became unreliable, vehicle kinematics, the type of sensor that is malfunctioning, and the probable cause of failure. In a first example, the information may be included within the CPM structure (e.g., within the Sensor Information Container). In a second example, the information may be included in a supplementary message that is transmitted at a lower frequency than Basic Safety messages (BSMs) or CPMs, and the supplementary message may use the same source ID and cryptographic certificate as a CPM.

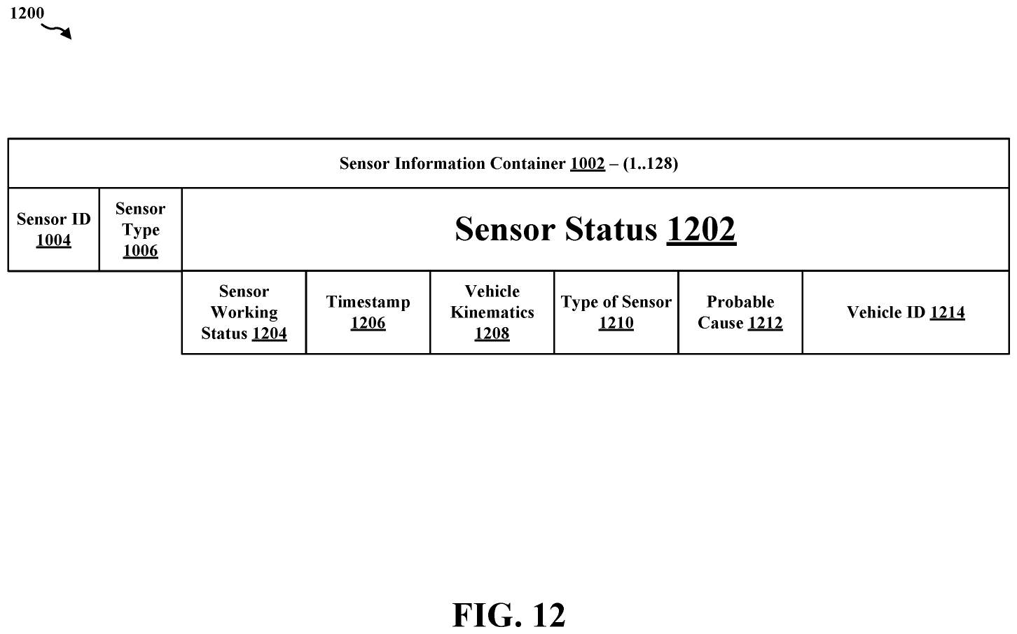

FIG. 12 is a diagram 1200 illustrating an example of a CPM including information pertaining to sensor status in accordance with various aspects of the present disclosure. As noted above, the CPM 702 may include a sensor information container 1002. In accordance with an aspect of this disclosure, the sensor information container 1002 may include an indication of sensor status 1202. In an example, when sensor(s) of a transmitting V2X device (e.g., a vehicle) become non-operational or unreliable, the indication of sensor status 1202 may be included in the CPM 702 from time(s) at which the sensor(s) became non-operational or unreliable. As used herein with respect to a sensor, the term “non-operational” may refer to a state in which a sensor is unable to output data/signals/information. In an example, a camera sensor may become non-operational if the camera sensor is destroyed. As used herein with respect to a sensor, the term “unreliable” may refer to a state in which a sensor is able to output data/signals/information, but the data/signals/information is unable to be relied upon. In an example, a camera sensor may become unreliable if a lens of the camera sensor obstructed by debris (e.g., mud), but is otherwise in an operational state.

The indication of sensor status 1202 may include a sensor working status 1204. The sensor working status 1204 may include an indication as to whether or not a sensor is non-operational or whether or not the sensor is unreliable. In one aspect, the sensor working status 1204 may be an “isWorking” Boolean field that indicates whether or not the sensor is working. In one aspect, the sensor working status 1204 may be an “isReliable” Boolean field that indicates whether or not the sensor is unreliable. In one aspect, the sensor working status 1204 may be a field that indicates whether a sensor is non-operational, operational, reliable, or unreliable. In an example, a receiving V2X device may utilize data in the sensor working status 1204 to determine whether or not data from the transmitting V2X device can be utilized.

The indication of sensor status 1202 may include a timestamp 1206 at which the sensor became non-operational or unreliable. In an example, the timestamp 1206 may include a date and a time at which the sensor became non-operational or unreliable. The timestamp 1206 may enable a receiving V2X device to determine whether to report a transmitting V2X device that has a non-operational or unreliable sensor. For instance, if the timestamp 1206 is located relatively temporally distant from a current time, there may be a high probability that another V2X device has reported the transmitting V2X device as having a sensor that has become non-operational or unreliable, and as such the receiving V2X device may choose not to report the transmitting V2X device.

The indication of sensor status 1202 may include an indication of vehicle kinematics 1208. The indication of vehicle kinematics 1208 may include a latitude of the V2X device (e.g., a vehicle), a longitude of the V2X device, an altitude of the V2X device, a heading of the V2X device, and/or a speed of the V2X device. The vehicle kinematics 1208 may be ascertained at a time corresponding to the timestamp 1206. The indication of the vehicle kinematics 1208 may be used by the receiving V2X device to estimate a current position, direction, and speed of the transmitting V2X device that has the non-operational or unreliable sensor. For instance, the indication of the vehicle kinematics 1208 may be used by the receiving V2X device to estimate a current position, direction, and speed of the transmitting V2X device when the V2X device is in a vehicular platoon. A vehicular platoon (which may also be referred to as a vehicle platoon) may enable vehicles to dynamically organize into a group which travels together. Each vehicle in the vehicular platoon may receive specific instructions from a vehicle leading the platoon. Vehicles in a vehicular platoon may arrange themselves at a relatively close proximity to other moving vehicles. A vehicular platoon may facilitate more efficient usage of road resources and fuels resources. When vehicles are arranged in a vehicular platoon, a leader of the vehicular platoon may send periodic or aperiodic instructions or messages to other vehicles in the vehicular platoon which guide the other vehicles and/or provide the other vehicles with information that enables the other vehicles to safely maintain the vehicular and navigate in the vehicular platoon. In an example, the receiving V2X device may utilize a dead-reckoning procedure or another estimation algorithm in order to estimate the current position, direction, and speed of the transmitting V2X device. Dead reckoning may refer to a process of calculating a current position of a moving object using a previously determined position of the object and incorporating estimates of speed, heading (or direction or course), and elapsed time. In an example, if an inertial measurement unit (IMU) of the transmitting V2X device becomes non-operational or unreliable, the receiving V2X device may utilize GNSS coordinates from the indication of the vehicle kinematics 1208 and ignore the heading and speed in the indication of the vehicle kinematics 1208. In another example, if a GNSS receiver of the transmitting V2X device becomes non-operational or unreliable, the receiving V2X device may utilize IMU sensor data (e.g., speed and heading) and ignore GNSS coordinates to compute predictions of future location(s) and/or driving path(s) of the transmitting V2X device.

The indication of sensor status 1202 may include an indication of a type of sensor 1210 that has become non-operational or unreliable. In an example, the indication of the type of sensor 1210 may include a GNSS sensor, a camera sensor, a radar sensor, a sound navigation and ranging (SONAR) sensor, and a light detection and ranging (LIDAR) sensor. In one aspect, a sensor may have a subtype. For instance, a camera may be a short range camera configured to capture images within a particular range or the camera may be a long range camera configured to capture images outside of the particular range. The indication of the type of sensor 1210 may be utilized by a receiving V2X device to determine which type(s) of data may still be utilized by the receiving V2X device. In an example, if a long-range radar sensor has become non-operational, but a camera sensor is still operational, objects detected as located relatively far away from the transmitting V2X device may not be utilized in decisions made by the receiving V2X device, but objects detected as being relatively close to the transmitting V2X device may be utilized in the decisions made by the receiving V2X device, as the objects that have been detected as being relatively close to the transmitting V2X device may be reported with a relatively high confidence.

The indication of sensor status 1202 may include an indication of a probable cause 1212 of the sensor becoming non-operational or unreliable. The indication of the probable cause 1212 of the sensor becoming non-operational or unreliable may also be referred to as a likely cause of the sensor becoming non-operational or unreliable. In an example, the probable cause 1212 of the sensor becoming non-operational or unreliable may be a software update, physical damage to the sensor due to an accident, or a malicious compromise of a cooperative awareness network (CAN). In another example, the probable cause 1212 of a camera sensor becoming non-operational or unreliable may be the camera sensor becoming obstructed or impaired by fog or a crack in a windshield.

The indication of sensor status 1202 may include a vehicle ID 1214. The vehicle ID 1214 may be an identifier for a transmitting V2X device that has a sensor that has become non-operational or unreliable. The vehicle ID 1214 may be the same as the source ITS-S ID 806. The vehicle ID 1214 may be a unique identification of the transmitting V2X device. The vehicle ID 1214 may also be utilized in other V2X messages such as a BSM, a CAM, a personal safety message (PSM), etc.

A transmitting V2X device may transmit the CPM 702 with or without the indication of the sensor status 1202. Furthermore, the indication of the sensor status 1202 may include information for each sensor of a V2X device.

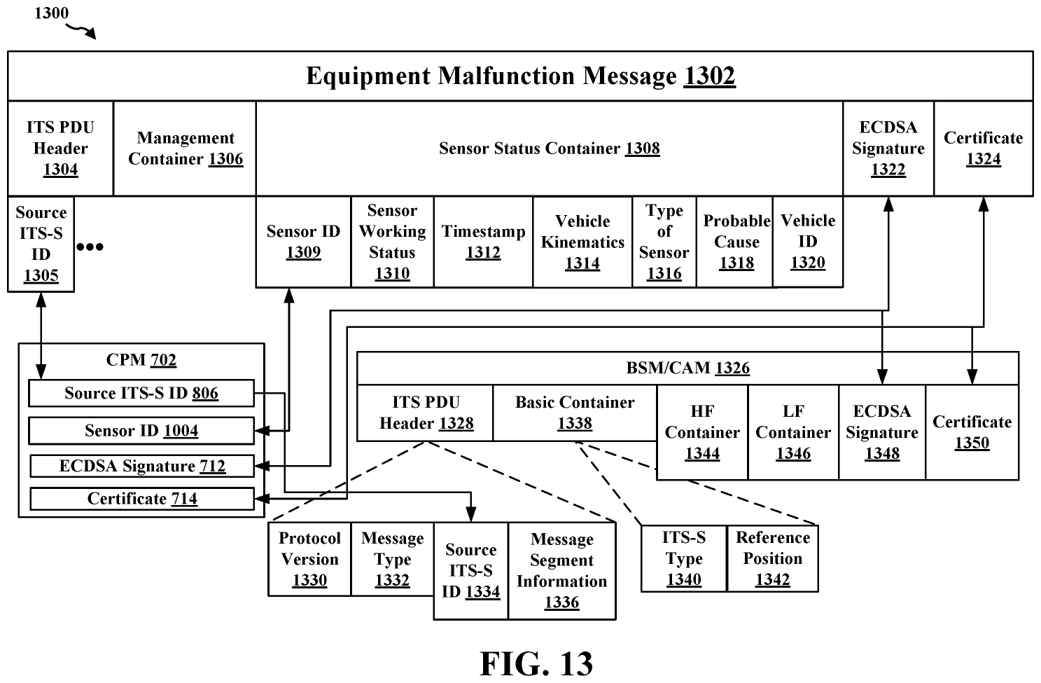

FIG. 13 is a diagram 1300 illustrating an example of an equipment malfunction message 1302 in accordance with various aspects of the present disclosure. In one aspect, if a V2X device determines that a sensor has become non-operational or unreliable (i.e., if a vehicle determines that an equipment malfunction has occurred with respect to the sensor), the V2X device may transmit the equipment malfunction message 1302 to indicate respective statuses of sensors of the V2X device. In one aspect, the V2X device may transmit the equipment malfunction message 1302 in place of the CPM 702. In another aspect, the V2X device may transmit the equipment malfunction message 1302 in addition to transmitting the CPM 702 (with or without the indication of the sensor status 1202). In an example, the V2X device may transmit the CPM 702 (or a BSM or a CAM) at a first periodicity (i.e., a first frequency) and the equipment malfunction message 1302 at a second periodicity (i.e., a second frequency), where the first periodicity is greater than the second periodicity. For instance, the V2X device may transmit the equipment malfunction message 1302 at the second periodicity as a sensor malfunction may be relatively rare. A receiving V2X device may use information in the equipment malfunction message 1302 in order to determine actions to take with respect to the CPM 702 (or the BSM or the CAM). In one aspect, a V2X device may not transmit the equipment malfunction message 1302 if a sensor is not working and the V2X device has come to a complete stop (e.g., the V2X device has a speed of zero miles per hour). The equipment malfunction message 1302 may utilize the same source ID and cryptographic certificate for both the equipment malfunction message 1302 and the CPM 702 (or the BSM or the CAM) in order to facilitate dissemination of information between vehicles. A source ID may refer to an identifier of an originating ITS-S(vehicle or RSU). Other ITS-S(vehicle or RSU) may identify the originating ITS-S by the source ID. The cryptographic certificate may refer to a digital document that binds a public key to an identity. The cryptographic certificate may be used to identify a device and mal also be used to sign information sent by the device. The cryptographic certificate may include a certificate chain that may prove an authenticity of the cryptographic certificate, and consequently an authenticity and an identity of the device. Stated differently, the equipment malfunction message 1302 and CPM 702 (or the BSM or the CAM) may the same source ITS-S ID 806 and the certificate 714.

The equipment malfunction message 1302 may include an ITS PDU header 1304. The ITS PDU header 1304 may be or include the ITS PDU header 704. For instance, the ITS PDU header 1304 may include a source ITS-S ID 1305 (and a protocol version, a message type, and message segment information). The equipment malfunction message 1302 may include a management container 1306. The management container 1306 may be or include the management container 706. The equipment malfunction message 1302 may include a sensor status container 1308. The sensor status container 1308 may be or include the indication of sensor status 1202. The sensor status container 1308 may include a sensor ID 1309 of a sensor that has become non-operational or unreliable. The sensor ID 1309 may be or include the sensor ID 1004. The sensor status container 1308 may include a sensor working status 1310, a timestamp 1312, an indication of vehicle kinematics 1314, an indication of a type of sensor 1316, an indication of a probable cause 1318, and a vehicle ID 1320. The sensor working status 1310 may be or include the sensor working status 1204, the timestamp 1312 may be or include the timestamp 1206, the indication of vehicle kinematics 1314 may be or include the indication of vehicle kinematics 1208, the indication of the type of sensor 1316 may be or include the indication of the type of sensor 1210, the indication of the probable cause 1318 may be or include the indication of the probable cause 1212, and the vehicle ID 1320 may be or include the vehicle ID 1214. The equipment malfunction message 1302 may include a ECDSA signature 1322. The ECDSA signature 1322 may be or include the ECDSA signature 712. The equipment malfunction message 1302 may include a certificate 1324. The certificate 1324 may be or include the certificate 714.

Portions of the equipment malfunction message 1302 may correspond to portions of a CPM, or a sensor data sharing message (SDSM), a CAM, or a BSM. A SDSM may refer to a message format that enables the sharing of sensor data between V2X-enabled vehicles and infrastructure. A CAM may refer to a message that enables the sharing of kinematic information between V2X-enabled vehicles and infrastructure. Kinematic information may include position, speed, acceleration, and/or heading. In one example, the source ITS-S ID 1305 may correspond to the source ITS-S ID 806, the sensor ID 1309 may correspond to the sensor ID 1004, the ECDSA signature 1322 may correspond to the ECDSA signature 712, and the certificate 1324 may correspond to the certificate 714.

In another example, a BSM/CAM 1326 may include a ITS PDU header 1328. The ITS PDU header 1328 may include a protocol version 1330, a message type 1332, a source ITS-S ID 1334, and message segment information 1336. The BSM/CAM 1326 may include a basic container 1338. The basic container 1338 may include an ITS-S type 1340 and a reference position 1342. The BSM/CAM 1326 may include a high frequency (HF) container 1344, a low frequency (LF) container 1346, an ECDSA signature 1348, and a certificate 1350. The HF container 1344 may include fast-changing (i.e., dynamic) status information of a vehicle ITS-S, such as heading or speed. The LF container 1346 may include slow-changing (i.e., static) vehicle data such as a status of exterior lights of a vehicle. The source ITS-S ID 1305 may correspond to the source ITS-S ID 1334, the ECDSA signature 1322 may correspond to the ECDSA signature 1348, and the certificate 1324 may correspond to the certificate 1350.

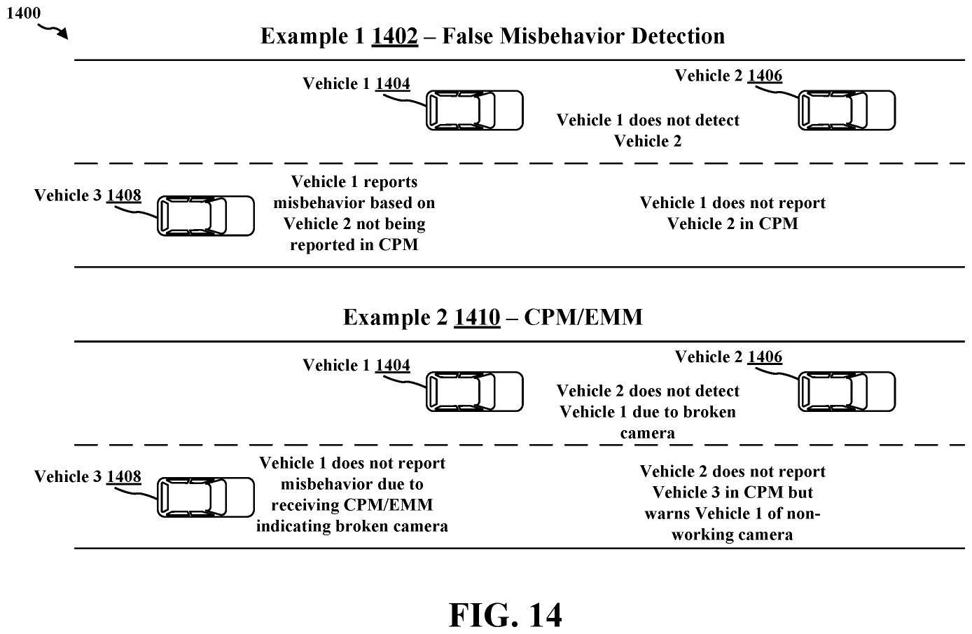

FIG. 14 is a diagram 1400 illustrating example aspects of misbehavior detection in V2X communication in accordance with various aspects of the present disclosure. In a first example 1402, a first vehicle 1404, a second vehicle 1406, and a third vehicle 1408 may be travelling on a road. The first vehicle 1404 may include a sensor (e.g., a camera) that has become unreliable. As the sensor has become unreliable, the first vehicle 1404 may not detect the second vehicle 1406. As the first vehicle 1404 has not detected the second vehicle 1406, the first vehicle 1404 may not report the second vehicle 1406 in a CPM broadcast by the first vehicle 1404. The third vehicle 1408 may receive the CPM. The third vehicle 1408 may also detect the second vehicle 1406 using sensors of the third vehicle 1408. The third vehicle 1408 may erroneously report the first vehicle 1404 as misbehaving due to the second vehicle 1406 not being reported in the CPM transmitted by the first vehicle 1404.

In a second example 1410, the first vehicle 1404, the second vehicle 1406, and the third vehicle 1408 may be travelling on a road. The first vehicle 1404 may include a broken camera. The first vehicle 1404 may not detect the third vehicle 1408 due to the broken camera. The first vehicle 1404 may transmit a CPM that includes an indication of sensor status (e.g., the CPM 702 including the indication of sensor status 1202) and/or the first vehicle 1404 may transmit an equipment malfunction message (EMM), such as the equipment malfunction message 1302. The CPM/EMM may indicate that the first vehicle 1404 has a broken camera. The third vehicle 1408 may receive the CPM/EMM. The third vehicle 1408 may detect the second vehicle 1406 using sensors of the third vehicle 1408. The third vehicle 1408 may not report the first vehicle 1404 as misbehaving based on receiving the CPM/EMM. Instead, the third vehicle 1408 may report the first vehicle 1404 as malfunctioning.

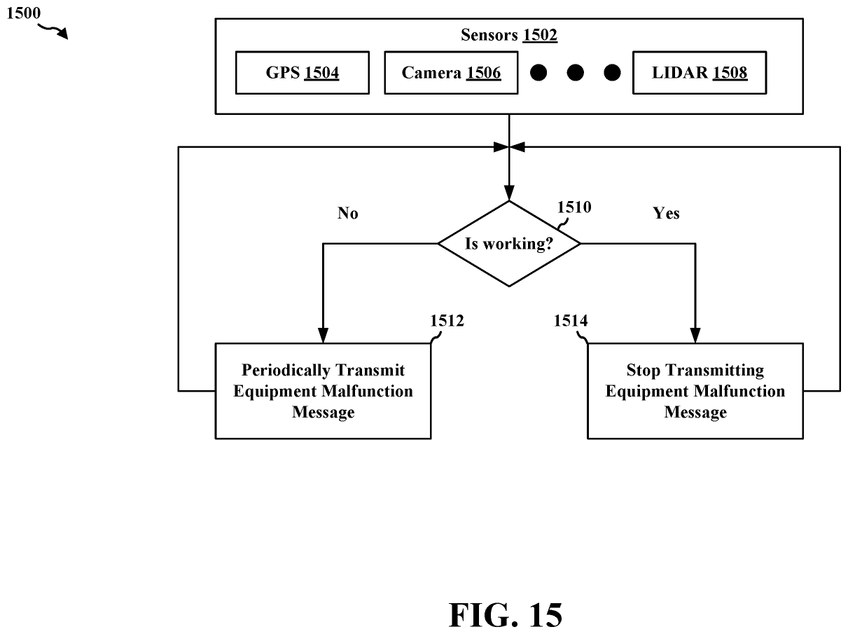

FIG. 15 is a diagram 1500 illustrating an example process for transmitting an equipment malfunction message in accordance with various aspects of the present disclosure. A V2X device may include sensors 1502. The sensors 1502 may include GPS 1504, a camera 1506, and/or a LIDAR 1508.

At 1510, the V2X device may determine whether the sensors 1502 are non-operational or unreliable (i.e., whether or not the sensors 1502 are working). At 1512, upon negative determination, the V2X device may periodically transmit the equipment malfunction message 1302. After a time interval (e.g., several milliseconds), the V2X device may return to 1510 and again determine whether the sensors 1502 are non-operational or unreliable. At 1514, upon positive determination, the V2X device may stop transmitting the equipment malfunction message 1302. After the time interval, the V2X device may return to 1510 and again determine whether the sensors 1502 are non-operational or unreliable.

As noted above, a transmitting V2X device (e.g., a first vehicle) may transmit the CPM 702 (including the indication of the sensor status 1202) and/or the equipment malfunction message 1302. A receiving V2X device (e.g., a second vehicle, a RSU) may receive and decode the indication of the sensor status 1202 in the CPM 702. Additionally, or alternatively, the receiving V2X device may receive and decode the equipment malfunction message 1302. The receiving V2X device may perform action(s) based on the (received and decoded) CPM 702 with the indication of the sensor status 1202 and/or the (received and decoded) equipment malfunction message 1302.

In one example, a misbehavior detection system of the receiving V2X device may modify misbehavior detection algorithm(s) based on the (received and decoded) CPM 702 with the indication of the sensor status 1202 and/or the (received and decoded) equipment malfunction message 1302. For example, the misbehavior detection system may modify the misbehavior detection algorithm(s) to not identify the transmitting V2X device as misbehaving.

In another example, the transmitting V2X device may be a first vehicle and the receiving V2X device may be a second vehicle, and the second vehicle may exclude the first vehicle from a misbehaving vehicle list if the first vehicle is outside of a safety zone associated with the second vehicle and/or if the first vehicle is stationary (e.g., the first vehicle has a speed of zero miles per hour).

In a further example, the transmitting V2X device may be a first vehicle that is a member of a vehicular platoon, and the receiving V2X device may transmit a reconfiguration message to the transmitting V2X device indicating that the first vehicle is to safely disengage from the vehicular platoon. The receiving V2X device may also inform other members of the vehicular platoon that the first vehicle is disengaging from the vehicular platoon. Additionally, or alternatively, the reconfiguration message may indicate that the first vehicle is to inform the other members of the vehicular platoon that the first vehicle is disengaging from the vehicular platoon.

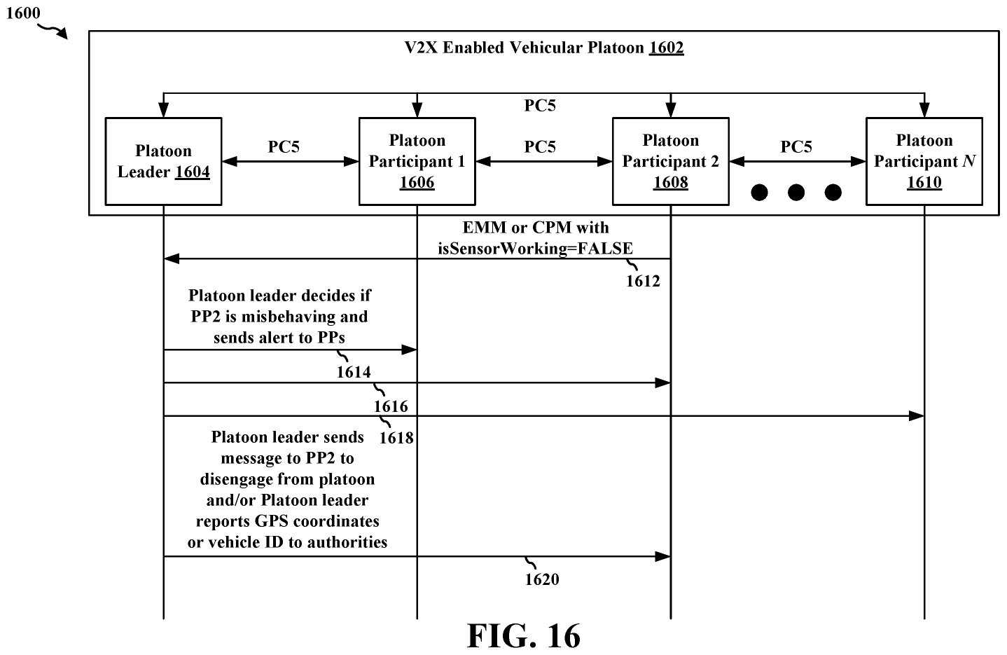

In yet another example, the receiving V2X device may be a relay, such as a RSU. The receiving V2X device may forward the CPM 702 including the indication of the sensor status 1202 (or a portion thereof) and/or the equipment malfunction message 1302 (or a portion thereof) to other V2X devices in an area associated with the RSU. FIG. 16 is a diagram 1600 illustrating example communications exchanged between a V2X enabled vehicular platoon 1602 in accordance with various aspects of the present disclosure. As used herein, a V2X enabled vehicular platoon may refer to a group of vehicles (e.g., two, three, four, ten, etc.) that travel together towards one or more locations by exchanging V2X communications. In an example, the V2X enabled vehicular platoon 1602 may include a platoon leader 1604, a first platoon participant 1606, a second platoon participant 1608, and an Nth platoon participant 1610, where N is a positive integer representing a total number of vehicles in the V2X enabled vehicular platoon 1602. The platoon leader 1604 may be a vehicle that coordinates travel of the V2X enabled vehicular platoon 1602. The platoon leader 1604, the first platoon participant 1606, the second platoon participant 1608, and the Nth platoon participant 1610 may respectively communicate with one another via a PC5 interface.

At 1612, the second platoon participant 1608 may transmit an equipment malfunction message (e.g., the equipment malfunction message 1302) and/or a CPM (e.g., the CPM 702 including the indication of sensor status 1202) to the platoon leader 1604. The platoon leader 1604 may determine whether the second platoon participant 1608 is misbehaving based on the equipment malfunction message and/or the CPM, and upon positive determination, at 1614, 1616, and 1618, the platoon leader 1604 may send alerts to the first platoon participant 1606, the second platoon participant 1608, and the Nth platoon participant 1610, respectively, where the alerts indicate that the second platoon participant 1608 is misbehaving. At 1620, the platoon leader 1604 may transmit a message to the second platoon participant 1608 indicating that the second platoon participant 1608 is to disengage from the V2X enabled vehicular platoon 1602. Additionally, or alternatively, the platoon leader may report GPS coordinates of the second platoon participant 1608 or a vehicle ID of the second platoon participant 1608 (from the equipment malfunction message and/or the CPM) to an authority.

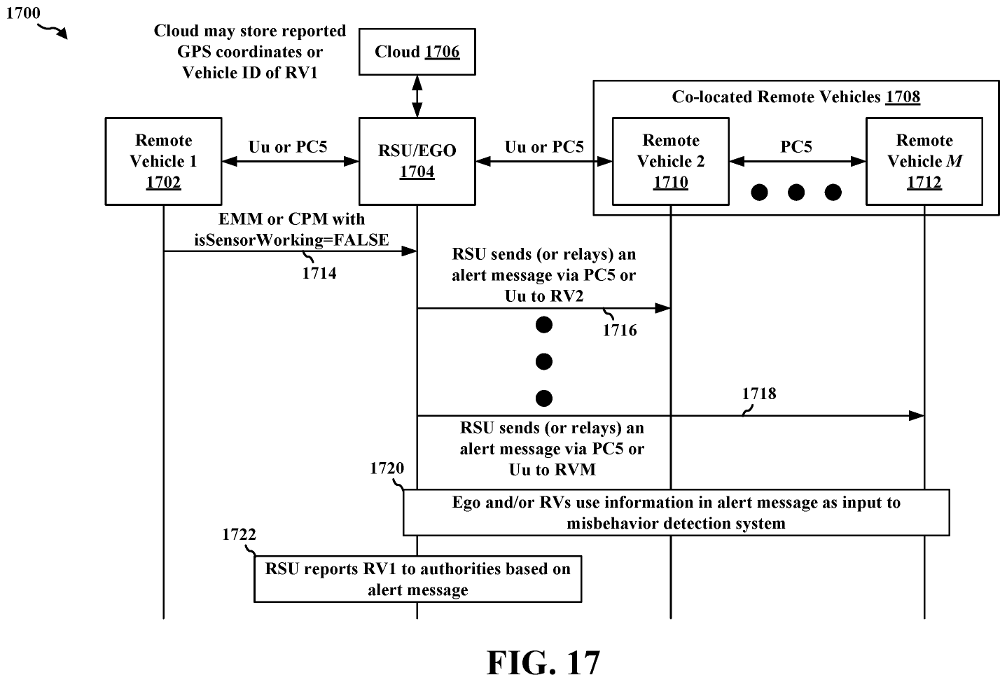

FIG. 17 is a diagram 1700 illustrating example communications exchanged between V2X devices in accordance with various aspects of the present disclosure. A first remote vehicle 1702 may communicate with a RSU (referred to in FIG. 17 as “RSU/EGO 1704”) located in a geographic area associated with RSU/EGO 1704 via Uu interface or a PC5 interface. RSU/EGO 1704 may communicate with the cloud 1706 (e.g., a server, a compute node, etc.). Co-located remote vehicles 1708 may be located in the geographic area associated with RSU/EGO 1704. The co-located remote vehicles may include a second remote vehicle 1710 and an Mth remote vehicle 1712, where M is a positive integer greater than two. RSU/EGO 1704 may communicate with the co-located remote vehicles 1708 via a Uu interface or a PC5 interface. The second remote vehicle 1710 may communicate with the Mth remote vehicle 1712 via a PC5 interface.

At 1714, the first remote vehicle 1702 may transmit an equipment malfunction message (e.g., the equipment malfunction message 1302) and/or a CPM (e.g., the CPM 702 including the indication of sensor status 1202) to RSU/EGO 1704 indicating that a sensor for the first remote vehicle 1702 is non-operational or unreliable. At 1716, RSU/EGO 1704 may send (or relay) an alert message to the second remote vehicle 1710 via the PC5 interface or the Uu interface, where the alert message indicates that the first remote vehicle 1702 has a sensor that has become non-operational or unreliable. At 1718, RSU/EGO 1704 may send (or relay) the alert message to the Mth remote vehicle 1712 via the PC5 interface or the Uu interface. RSU/EGO 1704 may also transmit GPS coordinates and/or a vehicle ID of the first remote vehicle 1702 to the cloud 1706.

At 1720, RSU/EGO 1704 and/or the co-located remote vehicles 1708 may utilize information in the alert message as input to a misbehavior detection system. At 1722, RSU/EGO 1704 may report the first remote vehicle 1702 to authorities based on the information in the alert message.

The CPM 702 including the indication of sensor status 1202 and/or the equipment malfunction message 1302 may be associated with various advantages. In an example, if a vehicle sensor or a stationary sensor becomes faulty, information included in a CPM may not be reliable or accurate. If an ego vehicle receives the CPM, the ego vehicle may perform inaccurate misbehavior detection based on the information included in the CPM. For example, a vehicle may not be flagged as misbehaving when the vehicle is in fact misbehaving (false negative), or depending on values of fields in the CPM, a vehicle may be flagged as misbehaving when in fact the vehicle is not misbehaving. In another example, if a remove vehicle is an emergency vehicle, falsely reporting the emergency vehicle as misbehaving may be impact safety. In a further example, falsely reporting a pedestrian as misbehaving may also impact safety. Falsely reporting a V2X device as misbehaving when the V2X device is not misbehaving or failing to report a V2X device as misbehaving when the V2X is misbehaving may be mitigated through transmission of the CPM 702 including the indication of the sensor status 1202 and/or transmission of the equipment malfunction message 1302.

In one aspect, a malicious attacker may compromise a transmission of a CPM by a transmitting V2X device. In such an aspect, transmission of the equipment malfunction message 1302 may enable a receiving V2X device to report the attack to authorities. For instance, if an equipment malfunction message (e.g., a periodic equipment malfunction message) is received by a receiving V2X device from a transmitting V2X device and a speed of the transmitting V2X device is increasing every second, the receiving V2X device may report the transmitting V2X device to the authorities.

Via transmission of the CPM 702 including the indication of sensor status 1202 and/or the equipment malfunction message 1302, the above-described technologies may be associated with an improved confidence in reporting a vehicle that has been compromised by an attacker as misbehaving. For instance, a receiving V2X device may be more confident that the misbehavior is due to the attacker rather than due to a faulty sensor. Furthermore, the above-described technologies may improve misbehavior detection techniques at both a transmitting V2X device and a receiving V2X device by not utilizing known faulty inputs (i.e., sensor data) that are unreliable due to a sensor becoming unreliable.

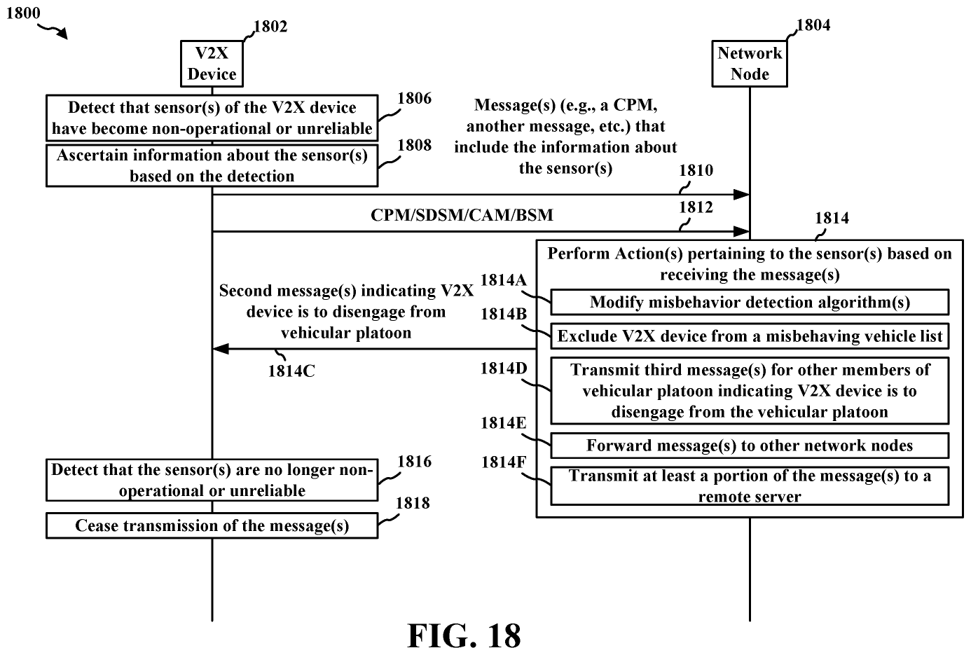

FIG. 18 is a diagram 1800 illustrating example communications exchanged between a V2X device 1802 and a network node 1804 in accordance with various aspects of the present disclosure. In an example, the V2X device 1802 may be a first vehicle, a first component of the first vehicle, a first UE, a first RSU, or a first network node. In an example, the network node 1804 may be a second vehicle, a second component of the second vehicle, a second UE, a second RSU, a second network node, a network entity, a mobile phone, a traffic management component, or a misbehavior component. A traffic management component may include smart traffic lights, smart traffic poles, and/or smart camera/LIDAR sensors.

At 1806, the V2X device 1802 may detect that sensor(s) of the V2X device 1802 have become non-operational or unreliable. At 1808, the V2X device may ascertain information about the sensor(s) based on detecting that the sensor(s) have become non-operational or unreliable. At 1810, the V2X device 1802 may transmit, for the network node 1804, message(s) that include information about the sensor(s) becoming non-operational or unreliable. The message(s) may include field(s) for the information about the sensor(s) becoming non-operational or unreliable. In an example, the message(s) may be or include a CPM, an equipment malfunction message, or another type of message. At 1812, if the message(s) transmitted at 1810 is not a CPM, the V2X device 1802 may transmit a CPM, a BSM, a SDSM, and/or a CAM in addition to transmitting the message(s) at 1810.

At 1814, the network node 1804 may perform action(s) pertaining to the sensor(s) based on receiving the message(s). In one example, at 1814A, the network node 1804 may modify misbehavior detection algorithm(s) based on the network node 1804 receiving the message(s). In another example, at 1814B, the network node 1804 may exclude the V2X device 1802 from a misbehaving vehicle list based on the network node 1804 receiving the message(s). In a further example, the V2X device 1802 may be a vehicle in a vehicular platoon, and at 1814C, the network node 1804 may transmit second message(s) for the V2X device 1802 indicating that the V2X device is to disengage from the vehicular platoon based on the network node 1804 receiving the message(s). In another example where the V2X device 1802 is a member in the vehicular platoon, at 1814D, the network node 1804 may transmit third message(s) for other members of the vehicular platoon indicating that the V2X device 1802 is to disengage from the vehicular platoon based on the network node 1804 receiving the message(s). In a further example, at 1814E, the network node 1804 may forward the message(s) to other network nodes (e.g., other vehicles, RSUs, UEs, etc.) based on the network node 1804 receiving the message(s). In yet another example, at 1814F, the network node 1804 may transmit at least a portion of the message(s) to a remote server. The remote server may be a connected cloud service that may be used for road safety and/or policing.

At 1816, the V2X device 1802 may detect that the sensor(s) are no longer non-operational or unreliable. At 1818, the V2X device 1802 may cease transmission of the message(s) based on detecting that the sensor(s) are no longer non-operational or unreliable.

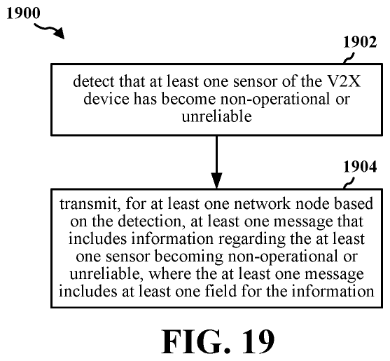

FIG. 19 is a flowchart 1900 of a method of wireless communication. The method may be performed by a V2X device (e.g., the UE 104, the UE 350, the UE 402, the UE 404, the UE 404, the UE 406, the UE 408, the first UE 504, the second UE 506, a member of the V2X enabled vehicular platoon 1602, the first remote vehicle 1702, the V2X device 1802, the apparatus 2304). In an example, the method may be performed by the misbehavior detector 198.

At 1902, the V2X device detects that at least one sensor of the V2X device has become non-operational or unreliable. For example, FIG. 18 at 1806 shows that the V2X device 1802 may detect that sensor(s) of the V2X device 1802 have become non-operational or unreliable. In an example, the at least one sensor may be or include the sensors 1502. In an example, 1902 may be performed by the misbehavior detector 198.

At 1904, the V2X device transmits, for at least one network node based on the detection, at least one message that includes information regarding the at least one sensor becoming non-operational or unreliable, where the at least one message includes at least one field for the information. For example, FIG. 18 at 1810 shows that the V2X device 1802 may transmit message(s) that include information about the sensor(s) becoming non-operational or unreliable. In an example, the at least one field may be or include the indication of the sensor status 1202 or the sensor status container 1308. In an example, 1904 may be performed by the misbehavior detector 198.

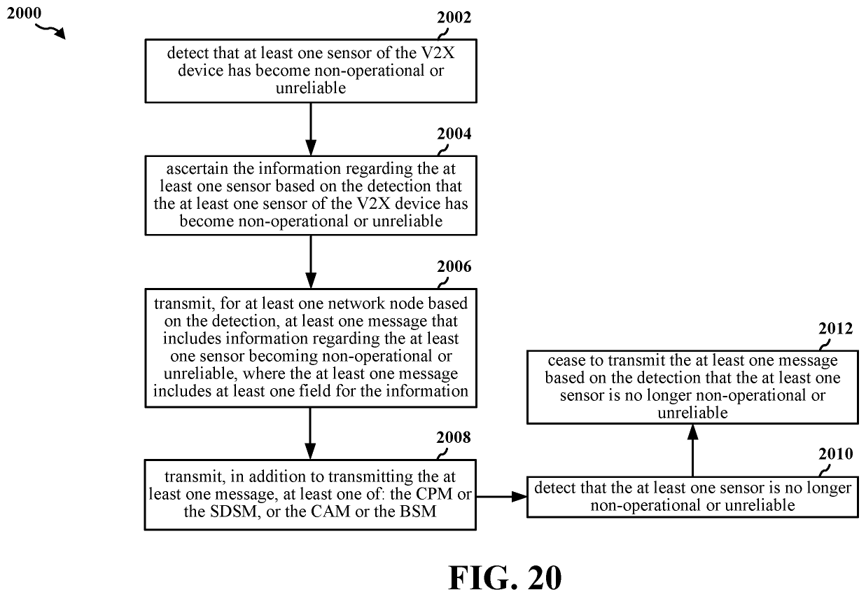

FIG. 20 is a flowchart 2000 of a method of wireless communication. The method may be performed by a V2X device (e.g., the UE 104, the UE 350, the UE 402, the UE 404, the UE 404, the UE 406, the UE 408, the first UE 504, the second UE 506, a member of the V2X enabled vehicular platoon 1602, the first remote vehicle 1702, the V2X device 1802, the apparatus 2304). In an example, the method (including the various aspects detailed below) may be performed by the misbehavior detector 198.

At 2002, the V2X device detects that at least one sensor of the V2X device has become non-operational or unreliable. For example, FIG. 18 at 1806 shows that the V2X device 1802 may detect that sensor(s) of the V2X device 1802 have become non-operational or unreliable. In an example, the at least one sensor may be or include the sensors 1502. In an example, 2002 may be performed by the misbehavior detector 198.

At 2006, the V2X device transmits, for at least one network node based on the detection, at least one message that includes information regarding the at least one sensor becoming non-operational or unreliable, where the at least one message includes at least one field for the information. For example, FIG. 18 at 1810 shows that the V2X device 1802 may transmit message(s) that include information about the sensor(s) becoming non-operational or unreliable. In an example, the at least one field may be or include the indication of the sensor status 1202 or the sensor status container 1308. In an example, 2006 may be performed by the misbehavior detector 198.

In one aspect, at 2010, the V2X device may detect that the at least one sensor is no longer non-operational or unreliable. For example, FIG. 18 at 1816 shows that the V2X device 1802 may detect that the sensor(s) are no longer non-operational or unreliable. In an example, 2010 may be performed by the misbehavior detector 198.

In one aspect, at 2012, the V2X device may cease to transmit the at least one message based on the detection that the at least one sensor is no longer non-operational or unreliable. For example, FIG. 18 at 1818 shows that the V2X device 1802 may cease transmission of the message(s) based on the detection at 1816. In an example, 2012 may be performed by the misbehavior detector 198.

In one aspect, the information regarding the at least one sensor may include at least one of: a first indication as to whether the at least one sensor is non-operational, a second indication of a time at which the at least one sensor became unreliable or non-operational, a third indication of kinematics of the V2X device, a fourth indication of at least one type of the at least one sensor, a fifth indication of a probable cause of the at least one sensor becoming non-operational or unreliable, or a sixth indication of an ID for the V2X device. For example, the aforementioned aspects may correspond to aspects described above in the description of FIGS. 12 and 13.

In one aspect, the kinematics of the V2X device may include a latitude, a longitude, an altitude, a heading, and a speed of the V2X device. For example, the indication of the vehicle kinematics 1208 may include a latitude, a longitude, an altitude, a heading, and a speed of the V2X device.

In one aspect, the at least one message may include a CPM, and the information regarding the at least one sensor may be included in a container of the CPM. For example, the container may be the sensor information container 1002 and the at least one message may be the CPM 702 described in FIGS. 7-12.

In one aspect, the at least one message may be different from a CPM or a SDSM, and where the at least one message may be different from a CAM or a BSM. For example, the at least one message may be the equipment malfunction message 1302, and the equipment malfunction message 1302 may be different from a CPM or a SDSM or a CAM or a BSM.

In one aspect, the at least one message may be transmitted at a first periodicity which is lower than a second periodicity at which the CPM or the SDSM are transmitted, and the at least one message may be transmitted at the first periodicity which is lower than a third periodicity at which the CAM or the BSM are transmitted. For example, the messages(s) transmitted at 1810 may be transmitted at a first periodicity which is lower than a second periodicity at which the CPM or the SDSM are transmitted, and the messages(s) transmitted at 1810 may be transmitted at the first periodicity which is lower than a third periodicity at which the CAM or the BSM are transmitted.

In one aspect, the at least one message may include a source ID and a cryptographic certificate that is used by the BSM. For example, the source ID may be the source ITS-S ID 1305 and the cryptographic certificate may be the certificate 1324.

In one aspect, at 2008, the apparatus may transmit, in addition to transmitting the at least one message, at least one of: the CPM or the SDSM, or the CAM or the BSM. For example, FIG. 18 at 1812 shows that the V2X device 1802 may transmit, in addition to transmitting the at least one message, at least one of: the CPM or the SDSM, or the CAM or the BSM. In an example, 2008 may be performed by the misbehavior detector 198.

In one aspect, the V2X device may be at least one of a vehicle, an ego vehicle, a UE, a RSU, or a network node, and the at least one network node may be at least one of a second UE, a second vehicle, a network entity, a second RSU, a mobile phone, a traffic management component, or a misbehavior component. For example, the V2X device 1802 may be at least one of a vehicle, an ego vehicle, a UE, a RSU, or a network node and the network node 1804 may be at least one of a second UE, a second vehicle, a network entity, a second RSU, a mobile phone, a traffic management component, or a misbehavior component. The misbehavior component (which may also be referred to as a misbehavior detection component) may refer to a device or an apparatus that is capable of determining misbehavior of a vehicle.

In one aspect, at least one of the V2X device or the at least one network node may be a member of a vehicular platoon. For example, the V2X device 1802 and/or the network node 1804 may be members of the V2X enabled vehicular platoon 1602.

In one aspect, the at least one sensor may include one or more of: a GNSS sensor, a camera sensor, a radar sensor, a sound navigation and ranging sensor, or a LIDAR sensor. For example, the sensor(s) of the V2X device 1802 may include a GNSS sensor, a camera sensor, a radar sensor, a SONAR sensor, and/or a LIDAR sensor. In one aspect, at 2004, the apparatus may ascertain the information regarding the at least one sensor based on the detection that the at least one sensor of the V2X device has become non-operational or unreliable. For example, FIG. 18 at 1808 shows that the V2X device 1802 may ascertain information about the sensor(s) based on the detection at 1806. In an example, 2004 may be performed by the misbehavior detector 198.

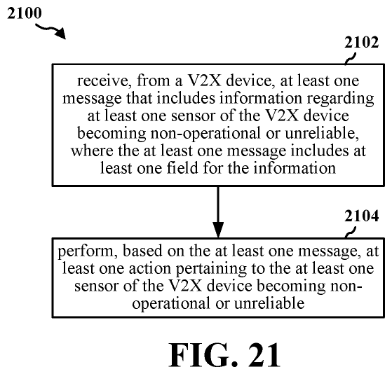

FIG. 21 is a flowchart 2100 of a method of wireless communication. The method may be performed by a network node (e.g., the base station 102, the base station 310, the network entity 2302, the network entity 2402). In an example, the method may be performed by the misbehavior detector 199.

At 2102, the network node receives, from a V2X device, at least one message that includes information about at least one sensor of the V2X device becoming non-operational or unreliable, where the at least one message includes at least one field for the information. For example, FIG. 18 at 1810 shows that the network node 1804 may receive message(s) from the V2X device 1802 that include information about sensor(s) of the V2X device 1802 becoming non-operational or unreliable. In an example, the at least one field may be or include the indication of the sensor status 1202 or the sensor status container 1308. In an example, the at least one sensor may be or include the sensors 1502. In an example, 2102 may be performed by the misbehavior detector 199.

At 2104, the network node performs, based on the at least one message, at least one action pertaining to the at least one sensor of the V2X device becoming non-operational or unreliable. For example, FIG. 18 at 1814 shows that the network node 1804 may perform action(s) pertaining to the sensor(s) based on the message(s) received at 1810. In an example, 2104 may be performed by the misbehavior detector 199.

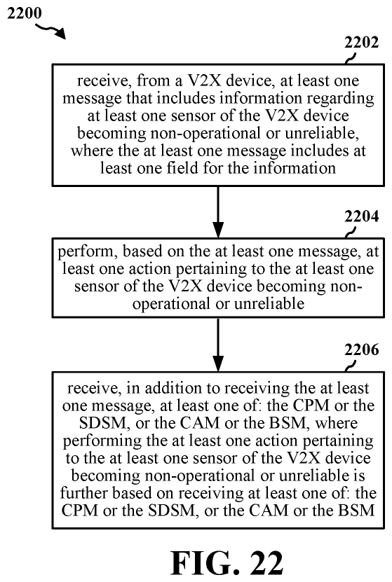

FIG. 22 is a flowchart 2200 of a method of wireless communication. The method may be performed by a network node (e.g., the base station 102, the base station 310, the network entity 2302, the network entity 2402). In an example, the method (including the various aspects detailed below) may be performed by the misbehavior detector 199.

At 2202, the network node receives, from a V2X device, at least one message that includes information about at least one sensor of the V2X device becoming non-operational or unreliable, where the at least one message includes at least one field for the information. For example, FIG. 18 at 1810 shows that the network node 1804 may receive message(s) from the V2X device 1802 that include information about sensor(s) of the V2X device 1802 becoming non-operational or unreliable. In an example, the at least one field may be or include the indication of the sensor status 1202 or the sensor status container 1308. In an example, the at least one sensor may be or include the sensors 1502. In an example, 2202 may be performed by the misbehavior detector 199.

At 2204, the network node performs, based on the at least one message, at least one action pertaining to the at least one sensor of the V2X device becoming non-operational or unreliable. For example, FIG. 18 at 1814 shows that the network node 1804 may perform action(s) pertaining to the sensor(s) based on the message(s) received at 1810. In an example, 2204 may be performed by the misbehavior detector 199.

In one aspect, the network node may include a vehicle, and performing the at least one action pertaining to the at least one sensor of the V2X device becoming non-operational or unreliable may include: modifying at least one misbehavior detection algorithm based on the at least one field of the at least one message. For example, FIG. 18 at 1814A shows that the at least one action may include modifying at least one misbehavior detection algorithm based on the at least one field of the at least one message.

In one aspect, the network node may include a vehicle, and performing the at least one action pertaining to the at least one sensor of the V2X device becoming non-operational or unreliable may include: excluding the V2X device from a misbehaving vehicle list maintained by the vehicle when the at least one message indicates that the V2X device is outside a threshold range of the vehicle or when the at least one message indicates that the V2X device has a speed that is less than a threshold value. For example, FIG. 18 at 1814B shows that the at least one action may include excluding the V2X device from a misbehaving vehicle list maintained by the vehicle when the at least one message indicates that the V2X device is outside a threshold range of the vehicle or when the at least one message indicates that the V2X device has a speed that is less than a threshold value.

In one aspect, the network node may include a RSU, and performing the at least one action pertaining to the at least one sensor of the V2X device becoming non-operational or unreliable may include: forwarding the at least one message to a set of additional network nodes. For example, FIG. 18 at 1814E shows that the at least one action may include forwarding the at least one message to a set of additional network nodes.

In one aspect, performing the at least one action pertaining to the at least one sensor of the V2X device becoming non-operational or unreliable may include: transmitting at least a portion of the at least one message to a remote server. For example, FIG. 18 at 1814F shows that the at least one action may include transmitting at least a portion of the at least one message to a remote server.

In one aspect, the information regarding the at least one sensor may include at least one of: a first indication as to whether the at least one sensor is non-operational, a second indication of a time at which the at least one sensor became unreliable or non-operational, a third indication of kinematics of the V2X device, a fourth indication of at least one type of the at least one sensor, a fifth indication of a probable cause of the at least one sensor becoming non-operational or unreliable, or a sixth indication of an ID for the V2X device. For example, the aforementioned aspects may correspond to aspects described above in the description of FIGS. 12 and 13.

In one aspect, the kinematics of the V2X device may include a latitude, a longitude, an altitude, a heading, and a speed of the V2X device. For example, the indication of the vehicle kinematics 1208 may include a latitude, a longitude, an altitude, a heading, and a speed of the V2X device.

In one aspect, the at least one message may include a CPM, and the information regarding the at least one sensor may be included in a container of the CPM. For example, the container may be the sensor information container 1002 and the at least one message may be the CPM 702 described in FIGS. 7-12.

In one aspect, the at least one message may be different from a CPM or a SDSM, and the at least one message may be different from a CAM or a BSM. For example, the at least one message may be the equipment malfunction message 1302, and the equipment malfunction message 1302 may be different from a CPM or a SDSM or a CAM or a BSM.

In one aspect, the at least one message may be received at a first periodicity which is lower than a second periodicity at which the CPM or the SDSM are received, and the at least one message may be received at the first periodicity which is lower than a third periodicity at which the CAM or the BSM are received. For example, the messages(s) received at 1810 may be received at a first periodicity which is lower than a second periodicity at which the CPM or the SDSM are received, and the messages(s) received at 1810 may be received at the first periodicity which is lower than a third periodicity at which the CAM or the BSM are received.

In one aspect, the at least one message may include a source ID and a cryptographic certificate that is used by the BSM, and performing the at least one action pertaining to the at least one sensor of the V2X device becoming non-operational or unreliable may be further based on the source ID and the cryptographic certificate. For example, the source ID may be the source ITS-S ID 1305 and the cryptographic certificate may be the certificate 1324.

In one aspect, at 2206, the apparatus may receive, in addition to receiving the at least one message, at least one of: the CPM or the SDSM, or the CAM or the BSM, where performing the at least one action pertaining to the at least one sensor of the V2X device becoming non-operational or unreliable may be further based on receiving at least one of: the CPM or the SDSM, or the CAM or the BSM. For example, FIG. 18 at 1812 shows that the network node 1804 may receive, in addition to receiving the at least one message, at least one of: the CPM or the SDSM, or the CAM or the BSM. In an example, 2206 may be performed by the misbehavior detector 199.

In one aspect, the V2X device may be at least one of a vehicle, an ego vehicle, a UE, a RSU, or a second network node, and the network node may be at least one of a second UE, a second vehicle, a network entity, a second RSU, a mobile phone, a traffic management component, or a misbehavior component. For example, the V2X device 1802 may be at least one of a vehicle, an ego vehicle, a UE, a RSU, or a network node and the network node 1804 may be at least one of a second UE, a second vehicle, a network entity, a second RSU, a mobile phone, a traffic management component, or a misbehavior component.

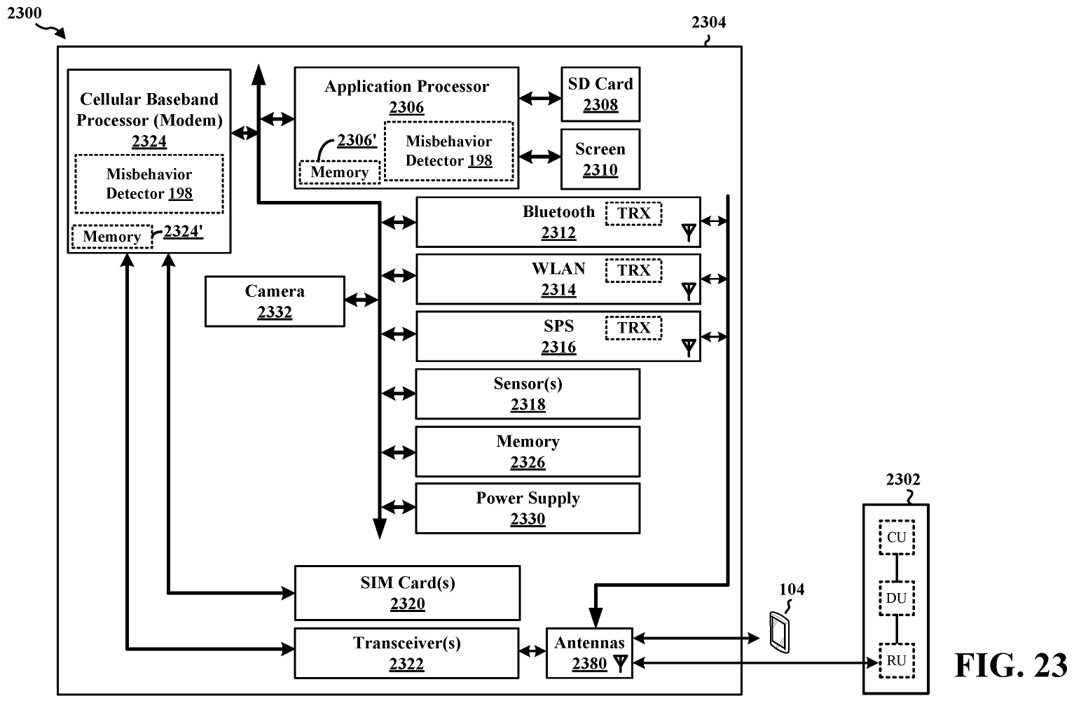

FIG. 23 is a diagram 2300 illustrating an example of a hardware implementation for an apparatus 2304. The apparatus 2304 may be a UE, a component of a UE, or may implement UE functionality. In some aspects, the apparatus 2304 may include a cellular baseband processor 2324 (also referred to as a modem) coupled to one or more transceivers 2322 (e.g., cellular RF transceiver). The cellular baseband processor 2324 may include on-chip memory 2324′. In some aspects, the apparatus 2304 may further include one or more subscriber identity modules (SIM) cards 2320 and an application processor 2306 coupled to a secure digital (SD) card 2308 and a screen 2310. The application processor 2306 may include on-chip memory 2306′. In some aspects, the apparatus 2304 may further include a Bluetooth module 2312, a WLAN module 2314, an SPS module 2316 (e.g., GNSS module), one or more sensor modules 2318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2326, a power supply 2330, and/or a camera 2332. The Bluetooth module 2312, the WLAN module 2314, and the SPS module 2316 may include an on-chip transceiver (TRX) (or in some cases, just a receiver (RX)). The Bluetooth module 2312, the WLAN module 2314, and the SPS module 2316 may include their own dedicated antennas and/or utilize the antennas 2380 for communication. The cellular baseband processor 2324 communicates through the transceiver(s) 2322 via one or more antennas 2380 with the UE 104 and/or with an RU associated with a network entity 2302. The cellular baseband processor 2324 and the application processor 2306 may each include a computer-readable medium/memory 2324′, 2306′, respectively. The additional memory modules 2326 may also be considered a computer-readable medium/memory. Each computer-readable medium/memory 2324′, 2306′, 2326 may be non-transitory. The cellular baseband processor 2324 and the application processor 2306 are each responsible for general processing, including the execution of software stored on the computer-readable medium/memory. The software, when executed by the cellular baseband processor 2324/application processor 2306, causes the cellular baseband processor 2324/application processor 2306 to perform the various functions described supra. The computer-readable medium/memory may also be used for storing data that is manipulated by the cellular baseband processor 2324/application processor 2306 when executing software. The cellular baseband processor 2324/application processor 2306 may be a component of the UE 350 and may include the memory 360 and/or at least one of the TX processor 368, the RX processor 356, and the controller/processor 359. In one configuration, the apparatus 2304 may be a processor chip (modem and/or application) and include just the cellular baseband processor 2324 and/or the application processor 2306, and in another configuration, the apparatus 2304 may be the entire UE (e.g., see UE 350 of FIG. 3) and include the additional modules of the apparatus 2304.

As discussed supra, the misbehavior detector 198 may be configured to detect that at least one sensor of the V2X device has become non-operational or unreliable. The misbehavior detector 198 may be configured to transmit, for at least one network node based on the detection, at least one message that includes information regarding the at least one sensor becoming non-operational or unreliable, where the at least one message includes at least one field for the information. The misbehavior detector 198 may be configured to detect that the at least one sensor is no longer non-operational or unreliable. The misbehavior detector 198 may be configured to cease to transmit the at least one message based on the detection that the at least one sensor is no longer non-operational or unreliable. The misbehavior detector 198 may be configured to transmit, in addition to transmitting the at least one message, at least one of: the CPM or the SDSM, or the CAM or the BSM. The misbehavior detector 198 may be configured to ascertain the information regarding the at least one sensor based on the detection that the at least one sensor of the V2X device has become non-operational or unreliable. The misbehavior detector 198 may be within the cellular baseband processor 2324, the application processor 2306, or both the cellular baseband processor 2324 and the application processor 2306. The misbehavior detector 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2304 may include a variety of components configured for various functions. In one configuration, the apparatus 2304, and in particular the cellular baseband processor 2324 and/or the application processor 2306, may include means for detecting that at least one sensor of the V2X device has become non-operational or unreliable. In one configuration, the apparatus 2304, and in particular the cellular baseband processor 2324 and/or the application processor 2306, may include means for transmitting, for at least one network node based on the detection, at least one message that includes information regarding the at least one sensor becoming non-operational or unreliable, where the at least one message includes at least one field for the information. In one configuration, the apparatus 2304, and in particular the cellular baseband processor 2324 and/or the application processor 2306, may include means for detecting that the at least one sensor is no longer non-operational or unreliable. In one configuration, the apparatus 2304, and in particular the cellular baseband processor 2324 and/or the application processor 2306, may include means for ceasing to transmit the at least one message based on the detection that the at least one sensor is no longer non-operational or unreliable. In one configuration, the apparatus 2304, and in particular the cellular baseband processor 2324 and/or the application processor 2306, may include means for transmitting, in addition to transmitting the at least one message, at least one of: the CPM or the SDSM, or the CAM or the BSM. In one configuration, the apparatus 2304, and in particular the cellular baseband processor 2324 and/or the application processor 2306, may include means for ascertaining the information regarding the at least one sensor based on the detection that the at least one sensor of the V2X device has become non-operational or unreliable. The means may be the misbehavior detector 198 of the apparatus 2304 configured to perform the functions recited by the means. As described supra, the apparatus 2304 may include the TX processor 368, the RX processor 356, and the controller/processor 359. As such, in one configuration, the means may be the TX processor 368, the RX processor 356, and/or the controller/processor 359 configured to perform the functions recited by the means.

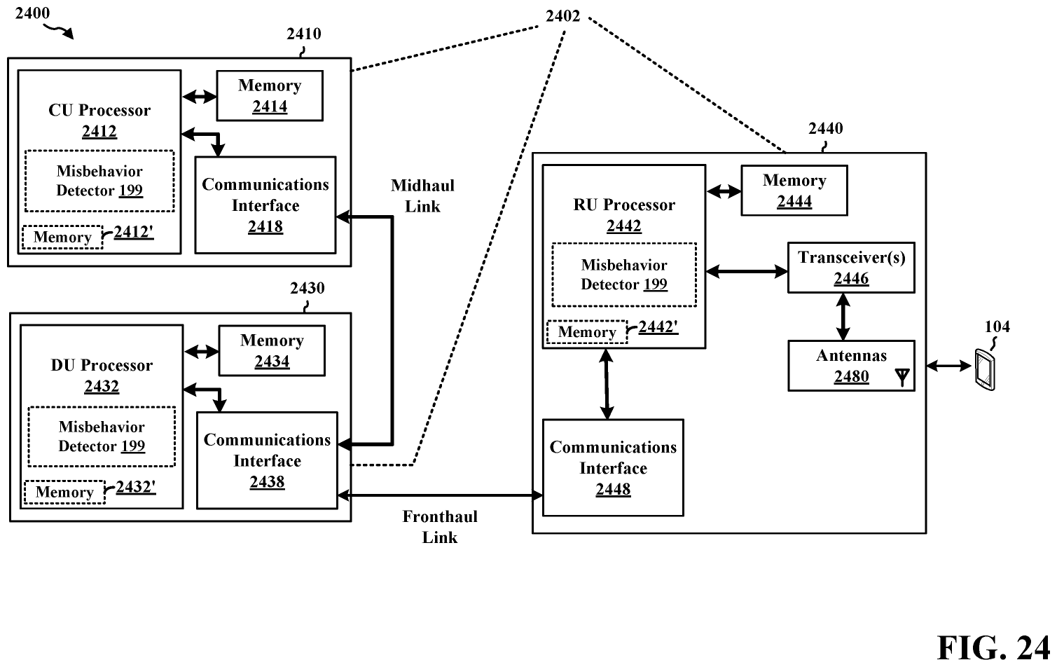

FIG. 24 is a diagram 2400 illustrating an example of a hardware implementation for a network entity 2402. The network entity 2402 may be a BS, a component of a BS, or may implement BS functionality. The network entity 2402 may include at least one of a CU 2410, a DU 2430, or an RU 2440. For example, depending on the layer functionality handled by the misbehavior detector 199, the network entity 2402 may include the CU 2410; both the CU 2410 and the DU 2430; each of the CU 2410, the DU 2430, and the RU 2440; the DU 2430; both the DU 2430 and the RU 2440; or the RU 2440. The CU 2410 may include a CU processor 2412. The CU processor 2412 may include on-chip memory 2412′. In some aspects, the CU 2410 may further include additional memory modules 2414 and a communications interface 2418. The CU 2410 communicates with the DU 2430 through a midhaul link, such as an F1 interface. The DU 2430 may include a DU processor 2432. The DU processor 2432 may include on-chip memory 2432′. In some aspects, the DU 2430 may further include additional memory modules 2434 and a communications interface 2438. The DU 2430 communicates with the RU 2440 through a fronthaul link. The RU 2440 may include an RU processor 2442. The RU processor 2442 may include on-chip memory 2442′. In some aspects, the RU 2440 may further include additional memory modules 2444, one or more transceivers 2446, antennas 2480, and a communications interface 2448. The RU 2440 communicates with the UE 104. The on-chip memory 2412′, 2432′, 2442′ and the additional memory modules 2414, 2434, 2444 may each be considered a computer-readable medium/memory. Each computer-readable medium/memory may be non-transitory. Each of the processors 2412, 2432, 2442 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the misbehavior detector 199 may be configured to receive, from a V2X device, at least one message that includes information about at least one sensor of the V2X device becoming non-operational or unreliable, where the at least one message includes at least one field for the information. The misbehavior detector 199 may be configured to perform, based on the at least one message, at least one action pertaining to the at least one sensor of the V2X device becoming non-operational or unreliable. The misbehavior detector 199 may be configured to receive, in addition to receiving the at least one message, at least one of: the CPM or the SDSM, or the CAM or the BSM, where performing the at least one action pertaining to the at least one sensor of the V2X device becoming non-operational or unreliable is further based on receiving at least one of: the CPM or the SDSM, or the CAM or the BSM. The misbehavior detector 199 may be within one or more processors of one or more of the CU 2410, DU 2430, and the RU 2440. The misbehavior detector 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2402 may include a variety of components configured for various functions. In one configuration, the network entity 2402 may include means for receiving, from a vehicle-to-everything (V2X) device, at least one message that includes information about at least one sensor of the V2X device becoming non-operational or unreliable, where the at least one message includes at least one field for the information. In one configuration, the network entity 2402 may include means for performing, based on the at least one message, at least one action pertaining to the at least one sensor of the V2X device becoming non-operational or unreliable. In one configuration, the network entity 2402 may include means for receiving, in addition to receiving the at least one message, at least one of: the CPM or the SDSM, or the CAM or the BSM, where performing the at least one action pertaining to the at least one sensor of the V2X device becoming non-operational or unreliable is further based on receiving at least one of: the CPM or the SDSM, or the CAM or the BSM. The means may be the misbehavior detector 199 of the network entity 2402 configured to perform the functions recited by the means. As described supra, the network entity 2402 may include the TX processor 316, the RX processor 370, and the controller/processor 375. As such, in one configuration, the means may be the TX processor 316, the RX processor 370, and/or the controller/processor 375 configured to perform the functions recited by the means.

Vehicle-to-everything (V2X) communications allow vehicles and other devices to communicate wirelessly with one another, and as such may facilitate or enable features such as cooperative navigation (i.e., vehicular platooning) and safety features. For instance, a V2X-equipped vehicle may broadcast a message (e.g., a collective perception message (CPM)) that includes information about objects (e.g., other vehicles, pedestrians, debris, etc.) perceived by the V2X-equipped vehicle and/or a kinematic state of the V2X-equipped vehicle, and other V2X devices may take actions (e.g., actions that facilitate cooperative navigation, safety-related actions, etc.) based on receiving the message. V2X communications may be dependent on trustworthiness of data included in the messages. For instance, if a sensor of the V2X-equipped vehicle is non-operational or unreliable (e.g., due to damage to the sensor, a software malfunction, etc.), a message transmitted by the V2X-equipped vehicle may be incorrect, and taking actions based on the message may also be incorrect. For instance, a V2X device may transmit incorrect data or fail to transmit correct data due to a hardware malfunction (e.g., a faulty sensor) or due to a malicious attack by an attacker. Misbehavior detection may refer to detecting that a V2X device (e.g., a V2X equipped vehicle, a road side unit (RSU), etc.) is transmitting incorrect data or that the V2X-device is failing to transmit correct data due to a malicious attack. If a V2X device is detected as misbehaving, the V2X device may be removed from a network and/or messages transmitted by the V2X device may be ignored by other vehicles for safety purposes. Some techniques for misbehavior detection may not inform V2X devices about details of a sensor of a V2X device that has become non-operational or unreliable, and as such, differentiating between misbehavior and a malfunction may be difficult. Furthermore, other techniques for misbehavior detection may rely upon receiver-side detection which may not be suitable in some scenarios.

Various technologies pertaining to improving misbehavior detection for V2X devices are described herein. In an example, a V2X device detects that at least one sensor of the V2X device has become non-operational or unreliable. The V2X transmits for at least one network node based on the detection, at least one message that includes information regarding the at least one sensor becoming non-operational or unreliable, where the at least one message includes at least one field for the information. Vis-à-vis detecting that the sensor of the V2X device has become non-operational or unreliable and transmitting the at least one message that includes information regarding the at least one sensor becoming non-operational or unreliable, the above-described technologies may result in more accurately distinguishing between misbehavior and malfunctions. Furthermore, the above-described technologies may improve misbehavior detection techniques by not utilizing known faulty inputs.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a vehicle-to-everything (V2X) device, including: detecting that at least one sensor of the V2X device has become non-operational or unreliable; and transmitting, for at least one network node based on the detection, at least one message that includes information regarding the at least one sensor becoming non-operational or unreliable, where the at least one message includes at least one field for the information.

Aspect 2 is the method of aspect 1, further including: detecting that the at least one sensor is no longer non-operational or unreliable; and ceasing to transmit the at least one message based on the detection that the at least one sensor is no longer non-operational or unreliable.

Aspect 3 is the method of any of aspects 1-2, where the information regarding the at least one sensor includes at least one of: a first indication as to whether the at least one sensor is non-operational, a second indication of a time at which the at least one sensor became unreliable or non-operational, a third indication of kinematics of the V2X device, a fourth indication of at least one type of the at least one sensor, a fifth indication of a probable cause of the at least one sensor becoming non-operational or unreliable, or a sixth indication of an identifier (ID) for the V2X device.

Aspect 4 is the method of aspect 3, where the kinematics of the V2X device include a latitude, a longitude, an altitude, a heading, and a speed of the V2X device.

Aspect 5 is the method of any of aspects 1-4, where the at least one message includes a cooperative perception message (CPM), and where the information regarding the at least one sensor is included in a container of the CPM.

Aspect 6 is the method of any of aspects 1-4, where the at least one message is different from a cooperative perception message (CPM) or a sensor data sharing message (SDSM), and where the at least one message is different from a cooperative awareness message (CAM) or a basic safety message (BSM).

Aspect 7 is the method of aspect 6, where the at least one message is transmitted at a first periodicity which is lower than a second periodicity at which the CPM or the SDSM are transmitted, and where the at least one message is transmitted at the first periodicity which is lower than a third periodicity at which the CAM or the BSM are transmitted.

Aspect 8 is the method of any of aspects 6-7, where the at least one message includes a source identifier (ID) and a cryptographic certificate that is used by the BSM.

Aspect 9 is the method of any of aspects 6-8, further including: transmitting, in addition to transmitting the at least one message, at least one of: the CPM or the SDSM, or the CAM or the BSM.

Aspect 10 is the method of any of aspects 1-9, where the V2X device is at least one of a vehicle, an ego vehicle, a user equipment (UE), a roadside unit (RSU), or a network node, and where the at least one network node is at least one of a second UE, a second vehicle, a network entity, a second RSU, a mobile phone, a traffic management component, or a misbehavior component.

Aspect 11 is the method of aspect 10, where at least one of the V2X device or the at least one network node is a member of a vehicular platoon.

Aspect 12 is the method of any of aspects 1-11, where the at least one sensor includes one or more of: a global navigation satellite system (GNSS) sensor, a camera sensor, a radar sensor, a sound navigation and ranging sensor, or a light detection and ranging (LIDAR) sensor.

Aspect 13 is the method of any of aspects 1-12, further including: ascertaining the information regarding the at least one sensor based on the detection that the at least one sensor of the V2X device has become non-operational or unreliable.

Aspect 14 is an apparatus for wireless communication at a vehicle-to-everything (V2X) device including a memory and at least one processor coupled to the memory and, based at least in part on information stored in the memory, the at least one processor is configured to perform a method in accordance with any of aspects 1-13.

Aspect 15 is an apparatus for wireless communications, including means for performing a method in accordance with any of aspects 1-13.

Aspect 16 is the apparatus of aspect 14 or 15 further including at least one of a transceiver or an antenna coupled to the at least one processor, where the at least one processor is configured to transmit the at least one message via at least one of the transceiver or the antenna.

Aspect 17 is a computer-readable medium (e.g., a non-transitory computer-readable medium) including instructions that, when executed by at least one processor, cause the at least one processor to perform a method in accordance with any of aspects 1-13.

Aspect 18 is a method of wireless communication at a network node, including: receiving, from a vehicle-to-everything (V2X) device, at least one message that includes information regarding at least one sensor of the V2X device becoming non-operational or unreliable, where the at least one message includes at least one field for the information; and performing, based on the at least one message, at least one action pertaining to the at least one sensor of the V2X device becoming non-operational or unreliable.

Aspect 19 is the method of aspect 18, where the network node includes a vehicle, and where performing the at least one action pertaining to the at least one sensor of the V2X device becoming non-operational or unreliable includes: modifying at least one misbehavior detection algorithm based on the at least one field of the at least one message.

Aspect 20 is the method of any of aspects 18-19, where the network node includes a vehicle, and where performing the at least one action pertaining to the at least one sensor of the V2X device becoming non-operational or unreliable includes: excluding the V2X device from a misbehaving vehicle list maintained by the vehicle when the at least one message indicates that the V2X device is outside a threshold range of the vehicle or when the at least one message indicates that the V2X device has a speed that is less than a threshold value.

Aspect 21 is the method of aspect 18, where the network node includes a road side unit (RSU), and where performing the at least one action pertaining to the at least one sensor of the V2X device becoming non-operational or unreliable includes: forwarding the at least one message to a set of additional network nodes.

Aspect 22 is the method of any of aspects 18-21, where performing the at least one action pertaining to the at least one sensor of the V2X device becoming non-operational or unreliable includes: transmitting at least a portion of the at least one message to a remote server.

Aspect 23 is the method of any of aspects 18-22, where the information regarding the at least one sensor includes at least one of: a first indication as to whether the at least one sensor is non-operational, a second indication of a time at which the at least one sensor became unreliable or non-operational, a third indication of kinematics of the V2X device, a fourth indication of at least one type of the at least one sensor, a fifth indication of a probable cause of the at least one sensor becoming non-operational or unreliable, or a sixth indication of an identifier (ID) for the V2X device.

Aspect 24 is the method of aspect 23, where the kinematics of the V2X device include a latitude, a longitude, an altitude, a heading, and a speed of the V2X device.

Aspect 25 is the method of any of aspects 18-24, where the at least one message includes a cooperative perception message (CPM), and where the information regarding the at least one sensor is included in a container of the CPM.

Aspect 26 is the method of any of aspects 18-24, where the at least one message is different from a cooperative perception message (CPM) or a sensor data sharing message (SDSM), and where the at least one message is different from a cooperative awareness message (CAM) or a basic safety message (BSM).

Aspect 27 is the method of aspect 26, where the at least one message is received at a first periodicity which is lower than a second periodicity at which the CPM or the SDSM are received, and where the at least one message is received at the first periodicity which is lower than a third periodicity at which the CAM or the BSM are received.

Aspect 28 is the method of any of aspects 26-27, where the at least one message includes a source identifier (ID) and a cryptographic certificate that is used by the BSM, and where performing the at least one action pertaining to the at least one sensor of the V2X device becoming non-operational or unreliable is further based on the source ID and the cryptographic certificate.

Aspect 29 is the method of any of aspects 26-28, further including: receiving, in addition to receiving the at least one message, at least one of: the CPM or the SDSM, or the CAM or the BSM, where performing the at least one action pertaining to the at least one sensor of the V2X device becoming non-operational or unreliable is further based on receiving at least one of: the CPM or the SDSM, or the CAM or the BSM.

Aspect 30 is the method of any of aspects 18 or 22-29, where the V2X device is at least one of a vehicle, an ego vehicle, a user equipment (UE), a roadside unit (RSU), or a second network node, and where the network node is at least one of a second UE, a second vehicle, a network entity, a second RSU, a mobile phone, a traffic management component, or a misbehavior component.

Aspect 31 is an apparatus for wireless communication at a network node including a memory and at least one processor coupled to the memory and, based at least in part on information stored in the memory, the at least one processor is configured to perform a method in accordance with any of aspects 18-30.

Aspect 32 is an apparatus for wireless communications, including means for performing a method in accordance with any of aspects 18-30.

Aspect 33 is the apparatus of aspect 31 or 32 further including at least one of a transceiver or an antenna coupled to the at least one processor, where the at least one processor is configured to receive the at least one message via at least one of the transceiver or the antenna.

Aspect 34 is a computer-readable medium (e.g., a non-transitory computer-readable medium) including instructions that, when executed by at least one processor, cause the at least one processor to perform a method in accordance with any of aspects 18-30.

What is claimed is:

1. An apparatus for wireless communication at a vehicle-to-everything (V2X) device, comprising:
a memory; and
at least one processor coupled to the memory and, based at least in part on information stored in the memory, the at least one processor is configured to:
detect that at least one sensor of the V2X device has become non-operational or unreliable; and
transmit, for at least one network node based on the detection, at least one message that includes information regarding the at least one sensor becoming non-operational or unreliable, wherein the at least one message includes at least one field for the information.

2. The apparatus of claim 1, wherein the at least one processor is further configured to:
detect that the at least one sensor is no longer non-operational or unreliable; and
cease to transmit the at least one message based on the detection that the at least one sensor is no longer non-operational or unreliable.

3. The apparatus of claim 1, wherein the information regarding the at least one sensor includes at least one of:
a first indication as to whether the at least one sensor is non-operational,
a second indication of a time at which the at least one sensor became unreliable or non-operational,
a third indication of kinematics of the V2X device,
a fourth indication of at least one type of the at least one sensor,
a fifth indication of a probable cause of the at least one sensor becoming non-operational or unreliable, or
a sixth indication of an identifier (ID) for the V2X device.

4. The apparatus of claim 3, wherein the kinematics of the V2X device include a latitude, a longitude, an altitude, a heading, and a speed of the V2X device.

5. The apparatus of claim 1, wherein the at least one message comprises a cooperative perception message (CPM), and wherein the information regarding the at least one sensor is included in a container of the CPM.

6. The apparatus of claim 1, wherein the at least one message is different from a cooperative perception message (CPM) or a sensor data sharing message (SDSM), and wherein the at least one message is different from a cooperative awareness message (CAM) or a basic safety message (BSM).

7. The apparatus of claim 6, wherein to transmit the at least one message, the at least one processor is configured to: transmit the at least one message at a first periodicity which is lower than a second periodicity associated with transmission of the CPM or the SDSM or transmit the at least one message at the first periodicity which is lower than a third periodicity associated with transmission of the CAM or the BSM.

8. The apparatus of claim 6, wherein the at least one message includes a source identifier (ID) and a cryptographic certificate that is used by the BSM.

9. The apparatus of claim 6, wherein the at least one processor is further configured to:
transmit, in addition to the at least one processor being configured to transmit the at least one message, at least one of:
the CPM or the SDSM, or
the CAM or the BSM.

10. The apparatus of claim 1, wherein the V2X device is at least one of a vehicle, an ego vehicle, a user equipment (UE), a roadside unit (RSU), or a network node, and wherein the at least one network node is at least one of a second UE, a second vehicle, a network entity, a second RSU, a mobile phone, a traffic management component, or a misbehavior component.

11. The apparatus of claim 10, wherein at least one of the V2X device or the at least one network node is a member of a vehicular platoon.

12. The apparatus of claim 1, wherein the at least one sensor includes one or more of:
a global navigation satellite system (GNSS) sensor,
a camera sensor,
a radar sensor,
a sound navigation and ranging sensor, or
a light detection and ranging (LIDAR) sensor.

13. The apparatus of claim 1, wherein the at least one processor is further configured to:
ascertain the information regarding the at least one sensor based on the detection that the at least one sensor of the V2X device has become non-operational or unreliable.

14. The apparatus of claim 1, wherein the apparatus is a wireless communication device comprising at least one of a transceiver or an antenna coupled to the at least one processor, and wherein to transmit the at least one message, the at least one processor is configured to transmit the at least one message via at least one of the transceiver or the antenna.

15. An apparatus for wireless communication at a network node, comprising:
a memory; and
at least one processor coupled to the memory and, based at least in part on information stored in the memory, the at least one processor is configured to:
receive, from a vehicle-to-everything (V2X) device, at least one message that includes information regarding at least one sensor of the V2X device becoming non-operational or unreliable, wherein the at least one message includes at least one field for the information; and
perform, based on the at least one message, at least one action pertaining to the at least one sensor of the V2X device becoming non-operational or unreliable.

16. The apparatus of claim 15, wherein the network node comprises a vehicle, and wherein to perform the at least one action pertaining to the at least one sensor of the V2X device becoming non-operational or unreliable, the at least one processor is configured to:
modify at least one misbehavior detection algorithm based on the at least one field of the at least one message.

17. The apparatus of claim 15, wherein the network node comprises a vehicle, and wherein to perform the at least one action pertaining to the at least one sensor of the V2X device becoming non-operational or unreliable, the at least one processor is configured to:
exclude the V2X device from a misbehaving vehicle list maintained by the vehicle when the at least one message indicates that the V2X device is outside a threshold range of the vehicle or when the at least one message indicates that the V2X device has a speed that is less than a threshold value.

18. The apparatus of claim 15, wherein the network node comprises a road side unit (RSU), and wherein to perform the at least one action pertaining to the at least one sensor of the V2X device becoming non-operational or unreliable, the at least one processor is configured to:
forward the at least one message to a set of additional network nodes.

19. The apparatus of claim 15, wherein to perform the at least one action pertaining to the at least one sensor of the V2X device becoming non-operational or unreliable, the at least one processor is configured to:
transmit at least a portion of the at least one message to a remote server.

20. The apparatus of claim 15, wherein the information regarding the at least one sensor includes at least one of:
a first indication as to whether the at least one sensor is non-operational,
a second indication of a time at which the at least one sensor became unreliable or non-operational,
a third indication of kinematics of the V2X device,
a fourth indication of at least one type of the at least one sensor,
a fifth indication of a probable cause of the at least one sensor becoming non-operational or unreliable, or
a sixth indication of an identifier (ID) for the V2X device.

21. The apparatus of claim 20, wherein the kinematics of the V2X device include a latitude, a longitude, an altitude, a heading, and a speed of the V2X device.

22. The apparatus of claim 15, wherein the at least one message comprises a cooperative perception message (CPM), and wherein the information regarding the at least one sensor is included in a container of the CPM.

23. The apparatus of claim 15, wherein the at least one message is different from a cooperative perception message (CPM) or a sensor data sharing message (SDSM), and wherein the at least one message is different from a cooperative awareness message (CAM) or a basic safety message (BSM).

24. The apparatus of claim 23, wherein to receive the at least one message, the at least one processor is configured to: receive the at least one message at a first periodicity which is lower than a second periodicity associated with reception of the CPM or the SDSM or receive the at least one message at the first periodicity which is lower than a third periodicity associated with reception of the CAM or the BSM.

25. The apparatus of claim 23, wherein the at least one message includes a source identifier (ID) and a cryptographic certificate that is used by the BSM, and wherein to perform the at least one action pertaining to the at least one sensor of the V2X device becoming non-operational or unreliable, the at least one processor is further configured to perform the at least one action based on the source ID and the cryptographic certificate.

26. The apparatus of claim 23, wherein the at least one processor is further configured to:
receive, in addition to receiving the at least one message, at least one of:
the CPM or the SDSM, or
the CAM or the BSM, wherein to perform the at least one action pertaining to the at least one sensor of the V2X device becoming non-operational or unreliable, the at least one processor is further configured to perform the at least one action based on at least one of:
the CPM or the SDSM, or
the CAM or the BSM.

27. The apparatus of claim 15, wherein the V2X device is at least one of a vehicle, an ego vehicle, a user equipment (UE), a roadside unit (RSU), or a second network node, and wherein the network node is at least one of a second UE, a second vehicle, a network entity, a second RSU, a mobile phone, a traffic management component, or a misbehavior component.

28. The apparatus of claim 15, wherein the apparatus is a wireless communication device comprising at least one of a transceiver or an antenna coupled to the at least one processor, and wherein to receive the at least one message, the at least one processor is configured to receive the at least one message via at least one of the transceiver or the antenna.

29. A method of wireless communication at a vehicle-to-everything (V2X) device, comprising:
detecting that at least one sensor of the V2X device has become non-operational or unreliable; and
transmitting, for at least one network node based on the detection, at least one message that includes information regarding the at least one sensor becoming non-operational or unreliable, wherein the at least one message includes at least one field for the information.

30. A method of wireless communication at a network node, comprising:
receiving, from a vehicle-to-everything (V2X) device, at least one message that includes information regarding at least one sensor of the V2X device becoming non-operational or unreliable, wherein the at least one message includes at least one field for the information; and
performing, based on the at least one message, at least one action pertaining to the at least one sensor of the V2X device becoming non-operational or unreliable.
